(19) United States
(12) Patent Application Publication
(10) Pub. No.: US 2026/0355973 A1
(43) Pub. Date: Nov. 12, 2026

(54) MOBILE ROBOTIC PLATFORM FOR PATIENT ASSISTANCE

(71) Applicant: Intuitive Autonomy Inc., San Jose, CA (US)

(72) Inventor: Thomas D. WANG, Sunnyvale, CA (US)

(73) Assignee: Intuitive Autonomy Inc., San Jose, CA (US)

(21) Appl. No.: 19/669,864

(22) Filed: May 6, 2026

Related U.S. Application Data
(60) Provisional application No. 63/802,876, filed on May 9, 2025.
(60) Provisional application No. 63/962,007, filed on Jan. 16, 2026.

(51) Int. Cl. B25J 11/00; B25J 9/16; B25J 13/00; B25J 13/08

(52) U.S. Cl. CPC B25J 11/009; B25J 9/162; B25J 9/1661; B25J 9/1664; B25J 9/1679; B25J 9/1697; B25J 13/006; B25J 13/084

(57) ABSTRACT

A mobile robotic platform for patient assistance includes a chassis adapted to perform one or more navigation tasks and a torso structure coupled to the chassis via a waist joint. The waist joint is configured to pitch the torso structure relative to the chassis, the waist joint being driven by one or more motors. One or more robotic arms mounted to the torso structure are to perform one or more patient manipulation tasks. A control system is configured to autonomously control the one or more navigation and manipulation tasks of the robotic platform.

### FIELD OF INVENTION

The present disclosure relates to mobile robotic platforms for healthcare applications, and more particularly to a wheeled robotic platform designed for patient lifting, transfer, and other patient manipulation tasks in elder care and healthcare facilities, home environments, etc.

### BACKGROUND

Healthcare facilities face increasing challenges in providing adequate physical assistance to patients, particularly in elder care environments where mobility support represents a substantial portion of daily care activities. Traditional patient handling methods often require multiple caregivers to safely perform tasks such as transferring patients between beds and wheelchairs, assisting with sit to stand movements, and repositioning individuals to prevent complications.

Manual patient handling places considerable physical strain on healthcare workers, contributing to high rates of musculoskeletal injuries and staff turnover in care facilities. The repetitive nature of lifting and transferring patients, combined with the substantial forces involved in supporting human body weight, creates ergonomic challenges that can lead to workplace injuries and reduced quality of care.

Existing mechanical patient handling devices, such as ceiling-mounted lifts and mobile hoists, provide some assistance but typically require manual operation and positioning by caregivers. These devices often have limited mobility, require significant setup time, and may not be readily available when needed. Additionally, many current solutions lack the flexibility to adapt to different patient sizes, room configurations, and care scenarios.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a mobile robotic platform is provided. The mobile robotic platform comprises a chassis adapted to perform one or more navigation tasks. The platform may be configured to perform torso pitching is specifically used to transfer patient load to the chassis via center-of-mass shift. The platform further comprises one or more robotic arms mounted to the torso structure to perform one or more manipulation tasks. A control system is configured to autonomously control the one or more navigation and manipulation tasks of the robotic platform.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a mobile robotic platform for patient assistance, in accordance with one or more embodiments.

FIGS. 2A and 2B depict alternative waist joint implementations, in accordance with one or more embodiments.

FIG. 3 illustrates a mobile robotic platform for patient assistance, in accordance with one or more embodiments.

FIGS. 4-6 depict various views of a mobile robotic platform, in accordance with one or more embodiments.

FIG. 7 illustrates a mobile robotic platform for patient assistance, in accordance with one or more embodiments.

FIG. 8 depicts a control system for a mobile robotic platform, in accordance with one or more embodiments.

FIG. 9 illustrates a diagram of a process of autonomous robotic assistance, in accordance with one or more embodiments;

FIG. 10 depicts a mobile robotic platform deployed to patient environments, according to in accordance with one or more embodiments;

FIG. 11 illustrates a diagram of human-robot interactions for a sit to stand task in accordance with one or more embodiments;

FIG. 12 illustrates an interaction logic flow between a mobile robotic platform and a caregiver wearable device (e.g., a wristband) to facilitate a coordinated assistive workflow;

FIG. 13 illustrates a flowchart of a series of acts in a method of autonomous robotic assistance in accordance with one or more embodiments;

FIG. 14 illustrates a block diagram of an exemplary computing device in accordance with one or more embodiments.

FIG. 15 illustrates a block diagram of an exemplary system in accordance with one or more embodiments.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The aging population in many countries has increased demand for mobility assistance services while simultaneously creating workforce shortages in healthcare facilities. This demographic shift has highlighted the need for technological solutions that can augment human caregivers and provide consistent, reliable assistance for routine patient handling tasks. In various embodiments, patients may include care recipients (e.g., those persons being assisted by the robot directly), caregivers (e.g., family, friends, doctors, nurses. etc.) or any other person or person whose tasks are assisted, aided or otherwise affected by the robot.

Robotic systems have emerged as potential solutions for various healthcare applications, offering the possibility of reducing physical demands on caregivers while maintaining patient safety and comfort. However, developing robotic platforms capable of safely interacting with humans in healthcare environments presents complex challenges related to payload capacity, stability, navigation in confined spaces, and intuitive operation by healthcare staff.

Mobile robotic platforms that combine navigation capabilities with manipulation functions (e.g., tasks) offer potential advantages for healthcare applications, as they can approach patients, provide physical support, and move between different locations within a facility. Such systems may help address staffing challenges while improving consistency and safety in patient care operations.

Mobile robotic platforms for patient assistance represent an advancing field in healthcare technology, addressing the growing need for automated solutions in elder care and mobility support environments. These platforms may be designed to perform various assistive tasks that traditionally require significant physical effort from healthcare workers, including patient lifting, sit to stand assistance, and transfer operations between different locations such as beds and wheelchairs.

In healthcare facilities such as nursing homes, rehabilitation centers, hospitals, etc., caregivers frequently encounter physically demanding tasks that can lead to injury and fatigue. Patient handling operations, particularly those involving lifting and transferring individuals with limited mobility, may present substantial challenges for human caregivers. The repetitive nature of these tasks, combined with the need to perform them multiple times throughout a day, can create ergonomic risks and operational inefficiencies. Attempts have been made to address these problems through the addition of various mechanical devices, such as hoists, to aid caregivers with lifting and transferring operations. However, these devices typically only operate at a single location and require active participation by caregivers. This can delay caregivers from seeing other patients, as they may have to wait for the mechanical devices to arrive, leading to cascading delays for other patients.

Embodiments address these and other deficiencies in the prior art by providing automated assistance for patient handling operations. Such platforms may be configured to navigate indoor environments while maintaining the capability to perform manipulation tasks that involve direct physical interaction with patients. The platforms may incorporate various sensing systems to perceive their surroundings and interact safely with both patients and healthcare staff. In some embodiments, such a platform may include a mobile robotic system specifically configured for safe human lifting via coordinated torso pitching, chassis positioning, and/or arm support to transfer load while maintaining stability.

The design of mobile robotic platforms for healthcare applications may balance several considerations, including payload capacity, maneuverability in confined spaces, safety during human interaction, and the ability to perform multiple types of assistive tasks. These platforms may be configured to operate in structured environments where standardized procedures and controlled conditions facilitate reliable autonomous operation while maintaining appropriate levels of human supervision.

Healthcare facilities may benefit from robotic assistance systems that can reduce the physical burden on staff while maintaining high standards of patient care and safety. Such systems may be particularly valuable in addressing staffing challenges and improving the consistency of patient handling procedures across different shifts and caregivers.

### Robotic Platform

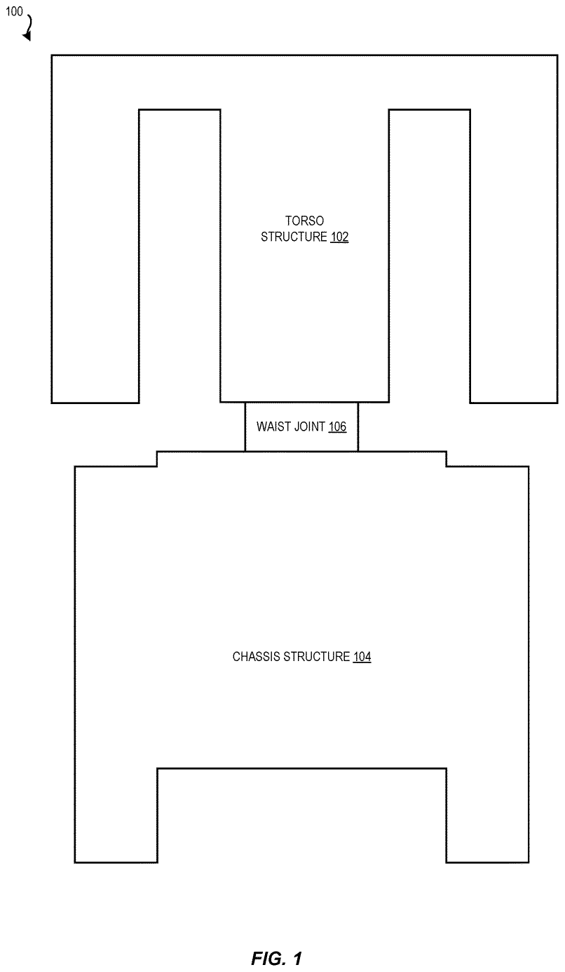

FIG. 1 illustrates a mobile robotic platform 100 for patient assistance, in accordance with one or more embodiments. Referring to FIG. 1, the mobile robotic platform may comprise a humanoid-inspired configuration designed for patient assistance and mobility support applications. The platform may feature an overall architecture that integrates a torso structure 102 and a chassis structure 104, which are connected via a waist joint 106. The torso structure includes an articulated upper body structure and the chassis structure includes a mobile base. This allows for both mobility capabilities and manipulation functionality for healthcare, homecare, and other patient environments.

As discussed, the mobile robotic platform 100 includes a chassis 104 that forms the foundational base structure of the platform 100. The chassis may be configured with a mobile arrangement that enables navigation across indoor surfaces or tight space while maintaining stability during patient interaction operations. As discussed, patients, as used herein, may include care recipients (e.g., those persons being assisted by the robot directly), caregivers (e.g., family, friends, doctors, nurses. etc.) or any other person or person whose tasks are assisted, aided or otherwise affected by the robot. The chassis may support the weight of both the robotic platform components and any payload encountered during patient handling tasks. The payload may include a patient, equipment for or associated with the patient, the patient's guests, etc., or some combination thereof. As discussed further, the mobile arrangement may include wheels, treads, stepping members (such as feet, hooves, etc.), or other propulsive technology.

A torso structure 102 may be mounted to the chassis 104 via waist joint 106, providing the primary framework for the upper body portion of the platform. The torso structure may be positioned to extend upward from the chassis and may be configured to house various components while presenting a form factor that facilitates interaction with patients and healthcare staff. The torso structure may include surfaces and mounting points for various subsystems of the platform.

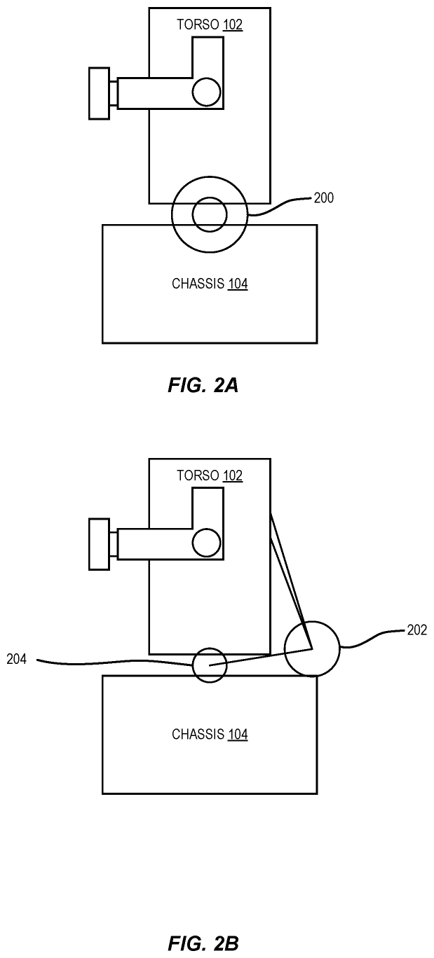

FIGS. 2A and 2B depict alternative waist joint implementations, in accordance with one or more embodiments. In some embodiments, the torso structure may be coupled to the chassis through a waist joint 200 that enables articulated movement between the upper body and base portions of the platform. The waist joint 200 may provide a connection point that allows the torso structure to move relative to the chassis while maintaining structural integrity and load-bearing capability during patient assistance operations.

The waist joint 200 may be configured to enable a pitching motion of the torso structure relative to the chassis. This pitching capability may allow the torso structure to lean forward and backward through a range of motion that facilitates patient interaction and weight transfer during lifting and other manipulation operations. The pitching motion may enable the platform to adjust the angle of the torso structure to accommodate different patient positions and assistance scenarios.

The waist joint may provide a pitch range that extends both above and below a neutral upright orientation. In some cases, the pitch range may extend at least 30 degrees in both forward and backward directions from the neutral position. This range of motion may enable the platform to lean forward to approach patients and lean backward to provide lifting assistance while maintaining balance and stability. Alternatively, in one example, a sit to stand task uses the robot's lower arms to lift a patient thus it requires robot body to lean forward a small angle; lift and transfer task uses the higher part of upper arms close to the shoulder joints and the top of the body close to the neck area to lift a patient, thus requires the robot to lean forward at a further angle in order for those parts of the robot to reach contact with the patient.

The waist joint may be driven by one or more motors that provide the torque needed to control the pitching motion of the torso structure. The motors may be configured to support the weight of the torso structure and any loads applied during patient handling operations. The motor configuration may provide precise control over the positioning and movement of the torso structure relative to the chassis.

As shown in FIG. 2A, in some cases, the waist joint 200 may be driven by dual motors that work together to provide the torque and control needed for patient assistance operations. The dual motor configuration may provide redundancy and increased torque capacity for handling substantial loads during patient lifting and transfer procedures. The motors may be coordinated to provide smooth and controlled movement of the torso structure. In such an instance, the motor(s) may be integrated inline with the waist joint.

Alternatively, as shown FIG. 2B, the waist joint may be driven by an external motor positioned remotely from the joint itself. In this configuration, the motor 202 may be located at a distance from the waist joint 204 and may transmit power and motion to the joint through mechanical linkages, cables, or other transmission mechanisms. The remote motor arrangement may provide design flexibility and may enable the use of larger or more powerful motors without adding bulk to the waist joint area.

The remote motor drive configuration shown in FIG. 2B may include an extensible support mechanism that operates from behind the torso structure. This mechanism may function similarly to a chair support system, where an extensible element extends from a rear position to provide support and actuation for the waist joint. The extensible support may comprise a linear actuator or telescoping mechanism that can extend and retract to control the pitch angle of the torso structure.

The extensible support mechanism may create a pivot arrangement where the waist joint serves as a fulcrum point while the remote motor provides the actuating force through the extensible element. This configuration may enable the use of less powerful motors while still providing substantial torque at the waist joint through mechanical advantage. The pivot arrangement may allow the platform to support heavier loads or provide greater lifting assistance while using motors with lower torque ratings.

The remote motor drive system may position the motor away from the waist joint area, which may reduce the complexity and bulk of the joint mechanism itself. The separation of the motor from the joint may allow for easier maintenance access and may enable the use of different motor types or configurations that might not fit within the constraints of the joint housing.

The torso structure may be configured to work in coordination with the waist joint to provide the range of motion and positioning capability needed for effective patient assistance. The combination of the torso structure and waist joint may enable the platform to adapt to different patient sizes, positions, and assistance requirements while maintaining stability and safety during operation.

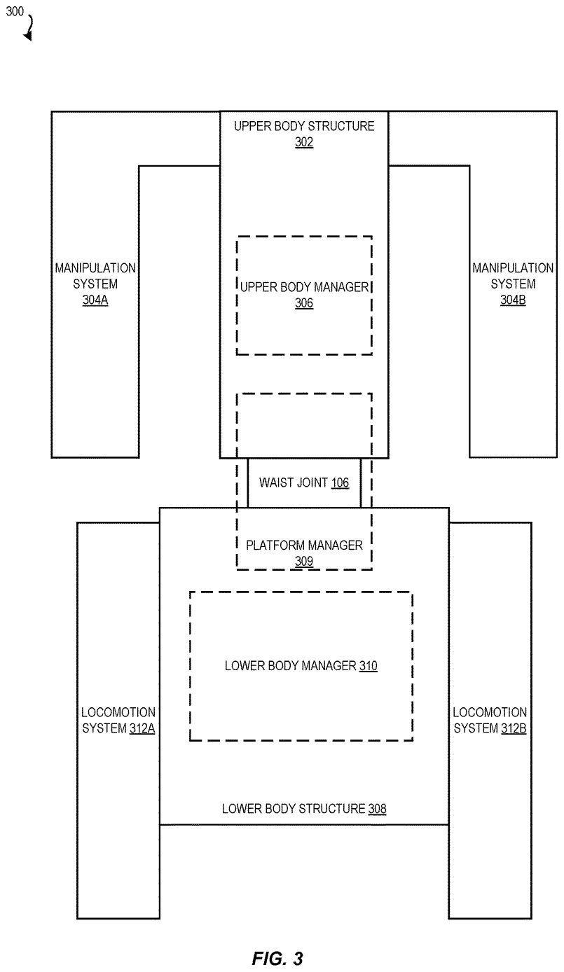

FIG. 3 illustrates a mobile robotic platform 300 for patient assistance, in accordance with one or more embodiments. As shown in FIG. 3, the torso structure may be divided into a number of subsystems, such as upper body structure 302 and manipulation system 304A and 304B. In some embodiments, the various subsystems of the robotic platform may be controlled using one or more controllers. For example, in some embodiments, the upper body structure 302 can include an upper body manager 306 and the lower body structure 308 can include a lower body manager 310. In some instances, these controllers may operate such that the upper body manager is in charge of upper body movements/manipulations (torso, arms, shoulders, etc.), and lower body manager 310 is in charge of lower body movements (locomotion system, etc.). However, in some implementations, the controllers may not be so rigidly assigned to specific platform components, instead, the controllers may work together as needed to control components regardless of where those components are located to effect the current task goals of the platform. Alternatively, in some embodiments, a unified system may be implemented which controls the coordinated movements and manipulations of the whole body. This enables the platform to behave like a human, e.g., whether for navigating the environment or manipulating patients, all of the robotic platform components (e.g., arms, torso, wheels, etc.) may move in coordination in order to perform an action.

In some embodiments, the upper body structure can include an upper body manager 306 which controls the operations performed by the torso, communicates with the chassis to coordinate movement and manipulation tasks, etc. Additionally, the manipulation system 304A/B may take on a number of forms depending on the tasks the robotic platform is expected to most frequently perform. For example, the manipulation system may include one or more robotic arms (e.g., a single arm, two arms in a humanoid-like arrangement, two arms in a task-optimized arrangement, or more than two arms arrangement for performing one or more tasks). The robotic arms may extend from the upper body structure to provide manipulation capabilities for the platform. The robotic arms may be positioned on opposing sides of the torso structure and may be configured to perform various handling and support functions during patient assistance operations. Each robotic arm may comprise multiple segments that enable articulated movement and positioning.

As discussed above, a waist joint 106 connects the torso to the chassis. In the example of FIG. 3, the chassis can be divided into a number of subsystems, such as lower body structure 308 and locomotion system 312A/B. The lower body structure can include a lower body manager 310 which controls the operations performed by the chassis, communicates with the torso to coordinate movement and manipulation tasks, etc. Additionally, the locomotion system 312 A/B can include wheels, treads, legs, feet, or other propulsive means or combinations thereof.

According to other aspects of the present disclosure, the mobile robotic platform may include one or more of the following features. The chassis may have one or more independently driven wheels, which may comprise four wheels. The platform may further comprise a steering system comprising one or more servo actuators configured to independently control steering angles of each wheel-associated steering linkage, such that the robotic platform is operable in different navigation modes including a crab steering mode, an omnidirectional steering mode, and a pivot turning mode. The steering system may include six servo actuators, with one additional servo actuator for each front wheel linkage.

The one or more robotic arms may be mounted to a lateral positioning mechanism configured to move the robotic arms outward or inward in a horizontal direction to vary an effective shoulder width of the platform. The platform may include two arms, with each robotic arm having at least three degrees of freedom. Each robotic arm may comprise a linear actuator configured to translate the arm mounting point relative to the torso structure. The lateral positioning mechanism may be configured to automatically adjust shoulder width based on detected aisle width or workspace geometry. In some embodiments, the torso structure may also be adjustable in the vertical direction (e.g., enable the torso structure to move up and/or down) to suit different patient heights.

The waist joint may be driven by dual motors and may have a pitch range of at least 30 degrees below and above the neutral upright orientation. The platform may further comprise a perception system that is capable of sensing surrounding environment and scenes. The perception system may include an optical LiDAR sensor positioned on a bottom portion of the chassis for mapping and navigation, one or more depth cameras positioned on a front central region of the robotic platform to obtain depth data of an environment in front of the robotic platform, ultrasonic proximity sensors disposed around side surfaces of the robotic platform to detect nearby obstacles, and tactile sensing elements disposed on an exterior surface of the robotic arms to detect contact forces.

The perception system may support mapping and navigation, manipulation perception and tactile sensing. The mapping and navigation may utilize LiDAR, ultrasonic sensors, IMU, wheel odometer, and cameras to enable robust SLAM, obstacle avoidance, and precise indoor navigation. The manipulation perception may include multiple RGB/Depth cameras positioned around the robot to provide maximal field of view of the user and task space, minimizing occlusions during assistive actions such as lifting, transfers, and repositioning. The tactile sensing may comprise electronic skin on high-contact surfaces that delivers real-time pressure maps for closed-loop force control, allowing the robot to lift and support users safely while maximizing comfort. The tactile sensing elements may comprise electronic skin panels (e.g., electronic skin sensor, or tactile electronic sensor) with distributed pressure sensing cells arranged across a surface exterior of the robotic arms.

The control system may be configured to fuse sensor data from the sensors. The control system may be configured to select among different steering mode profiles based on environmental classification derived from the perception system. The control system may be configured to transition between a navigation mode and a manipulation mode based on proximity thresholds detected from the RGB-D cameras. The platform may further comprise a sensor fusion module configured to apply hierarchical weighting to sensor streams wherein the LiDAR sensor is assigned primary priority for global navigation, the depth camera is assigned primary priority for mid-range semantic manipulation, and the tactile sensing elements are assigned primary priority for near-contact and contact safety control. The control system may be configured to maintain a compliance envelope based at least on signals from the tactile electronic skin such that manipulator motion is limited to avoid excessive contact forces during human interaction.

The platform may further comprise a patient support surface positioned on the torso structure, the patient support surface being arranged to contact and support the chest and/or head of a person during lifting, sit to stand, stand to sit, or transfer assistance cycles. The patient support surface may comprise a rigid padded plate, an articulated surface capable of angular adjustment, a flexible foam or inflatable material, or a hybrid assembly including a rigid backing plate coupled to a soft or flexible surface contact layer.

The chassis may comprise a base structural frame shaped like “A” geometry with two leg struts angled outward with wheels at ends. The chassis and the torso structure may be positioned in a posture that is ready to lift a person. In some embodiments, the platform may include hand support. Hand supports may include handles (or similar grippable structures) on the back of robot body for patient to grab hold of during lift and transfer tasks. The platform may further comprise a foot and/or knee support. The chassis may move away from the person while the torso structure pitches close to the patient to be ready to lift the person. The chassis may move close to the person while the torso structure pitches upward to lift the person. The one or more robotic arms may support the person from underneath the arms to hold the person steady, which may include using a sling. The platform may further comprise a screen to communicate with a person. The platform may further comprise a head structure that can be reconfigured to provide a patient support surface by removing, rotating, or folding the head structure.

Described herein are autonomous and semi-autonomous robotic systems configured to assist patients and caregivers in healthcare and home-care environments. In various embodiments, a mobile robotic platform includes a chassis configured to perform navigation tasks and a torso structure coupled to the chassis via an actuated waist joint that pitches the torso relative to the chassis. One or more robotic arms are mounted to the torso structure and are controllable to perform patient manipulation tasks such as stabilization, lifting, sit to stand assistance, stand to sit assistance, and transfers between locations (e.g., bed-to-chair, chair-to-toilet, or wheelchair-to-bed). A control system coordinates navigation and manipulation, optionally using multi-modal sensing to perceive an environment, identify a patient and/or caregiver, and execute one or more assistance behaviors in response to a request.

In some embodiments, the chassis includes a locomotion system that may be wheel-based, tread-based, or a hybrid of wheels and treads. For wheel-based embodiments, the locomotion system may include a plurality of wheels coupled to a base structural frame. One or more wheels may be driven, and one or more wheels may be steerable. In certain implementations, one or more servo actuators are configured to independently control steering angles of respective wheels via associated steering linkages, thereby enabling different steering behaviors and precise maneuvering in constrained spaces (e.g., patient rooms, bathrooms, hallways, and elevator vestibules).

The mobile robotic platform may be operable in multiple navigation modes, including, by way of example, a crab steering mode, an omnidirectional steering mode, a pivot turning mode, and an Ackerman mode. In some embodiments, the control system stores a plurality of steering mode profiles and selects among the profiles based on an environmental classification derived from a perception system (e.g., identifying an open hallway versus a cluttered patient room). The control system may further transition between a navigation mode and a manipulation mode based on proximity thresholds, such as switching from a global-navigation behavior to a fine-positioning behavior when the platform enters a defined vicinity of a patient, bed, wheelchair, or caregiver.

In certain embodiments, the chassis includes a base structural frame having an A-frame geometry. For example, the frame may include at least two leg struts angled outward with wheels at their distal ends to increase lateral stability during patient handling. Such an A-frame arrangement may also create a clearance region to accommodate a patient's feet, a wheelchair footrest, or furniture legs while the torso pitches toward the patient.

The torso structure is coupled to the chassis via a waist joint configured to pitch the torso relative to the chassis. The waist joint may be driven by one or more motors, and in some embodiments by dual motors, to provide increased torque capacity, redundancy, smoother motion, and/or improved control authority during patient manipulation tasks. Pitching the torso can shift the effective contact region and support surfaces of the platform relative to the patient while maintaining a stable base of support at the chassis.

One or more robotic arms are mounted to the torso structure and are controllable to perform patient manipulation tasks. In some embodiments, each robotic arm is mounted to a shoulder joint configured to move the arm outward or inward in a generally horizontal direction to vary an effective shoulder width of the platform. By adjusting the shoulder width, the platform can adapt to environmental constraints (e.g., doorway widths, furniture spacing) and/or patient characteristics (e.g., body size, arm position, preferred support points). In some implementations, the control system automatically adjusts shoulder width based on sensed environmental dimensions and/or inferred or stored patient characteristics.

The torso structure may include one or more patient support surfaces positioned to contact and support a patient during assistance. For example, a patient support surface may be arranged to contact and support a chest and/or head of a patient during a lift or transfer. In some embodiments, a head structure is reconfigurable to provide an additional or alternative patient support surface. The platform may further include one or more handles, and/or foot and/or knee supports to aid patient positioning and to provide predictable contact locations. In some embodiments, the platform includes a screen or other user interface to communicate instructions, prompts, and status information to the patient and/or caregiver.

During certain assistance behaviors, the robotic arms may be configured to support the patient from underneath the patient's arms (e.g., in an axillary support posture) to hold the patient steady while the torso pitches and/or while the chassis repositions. In other implementations, the arms may provide lateral stabilization, guidance for sit to stand trajectories, or controlled assistance forces as determined by the control system.

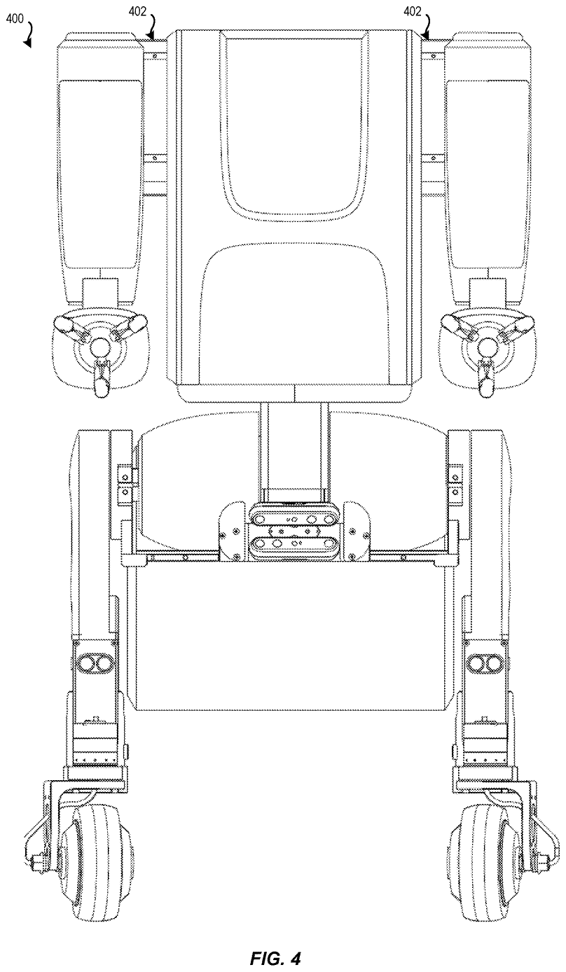

FIGS. 4-6 depict various views of a mobile robotic platform, in accordance with one or more embodiments. Referring to FIG. 4, the platform architecture may be viewed from a front perspective 400, illustrating the spatial arrangement of the major components. The chassis may exhibit a geometric configuration that provides a stable base while maintaining a compact footprint suitable for indoor navigation. The torso structure may be centrally positioned on the chassis, with the robotic arms extending outward from the central body section.

The overall form factor shown in FIG. 4 may enable the platform to approach patients from various angles while maintaining clearance for the robotic arms to perform manipulation tasks. The arrangement of components may facilitate access to patients in different positions, such as seated or lying configurations.

With continued reference to FIG. 4, the platform may incorporate a lateral positioning mechanism 402 that allows adjustment of the robotic arms relative to the torso structure. This mechanism may enable variation of the effective shoulder width of the platform to accommodate different patient sizes and environmental constraints.

The front view of the platform may also illustrate the vertical arrangement of components and the overall proportions of the system. The chassis may provide a foundation that supports the torso structure at an appropriate height for patient interaction. The robotic arms may extend from the torso structure at positions that correspond to natural arm placement for human-like interaction patterns.

The platform architecture shown in FIG. 4 may present a configuration where the various components work together to provide both stability and functionality. The chassis may maintain contact with the ground surface while the torso structure and robotic arms may be positioned to interact with patients at appropriate heights and angles.

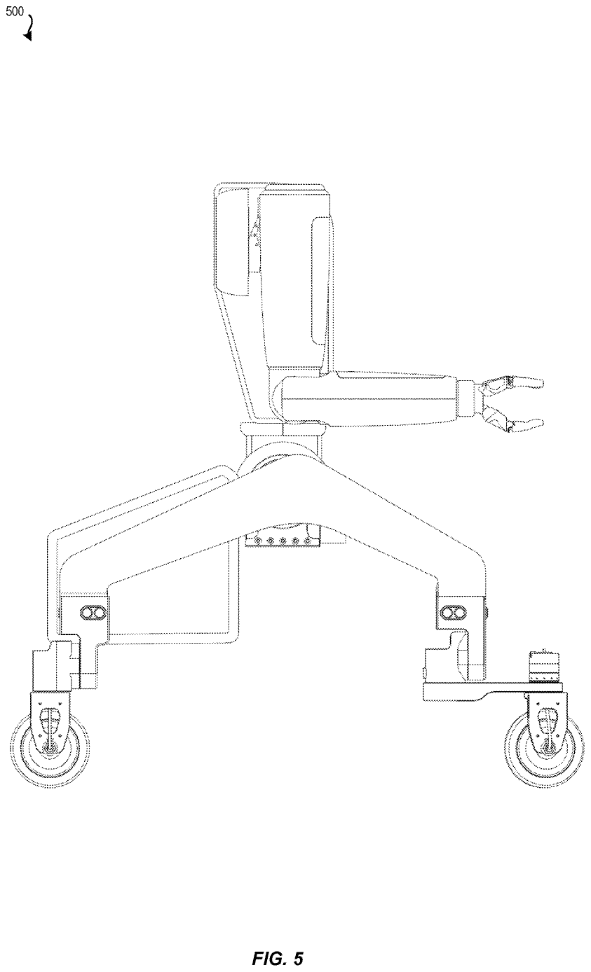

As shown in FIG. 5, a side view 500 of the platform further illustrates one arrangement of the chassis, with forward and rearward supports, creating a stable wide angled base.

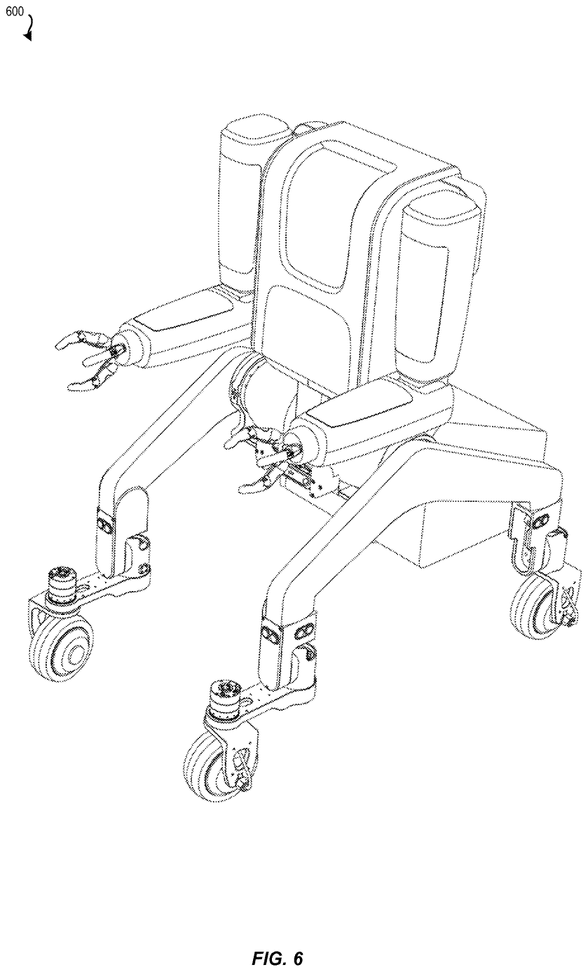

As shown in FIG. 6, the perspective view may reveal the three-dimensional relationships between the platform components. The chassis, torso structure, and robotic arms may be integrated into a cohesive system that combines mobility, stability, and manipulation capabilities. The overall architecture may enable the platform to perform complex patient assistance tasks while maintaining safe operation in healthcare environments.

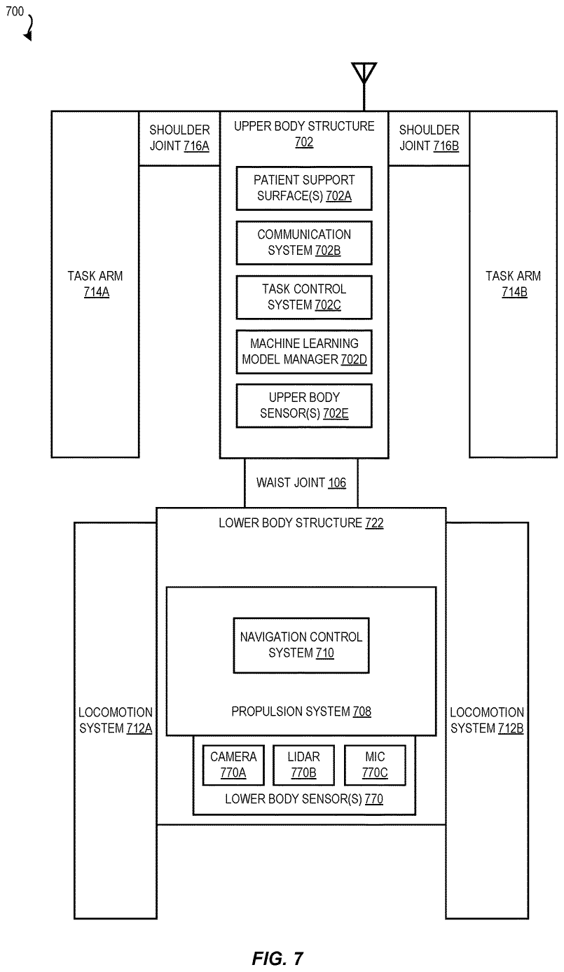

FIG. 7 illustrates a mobile robotic platform for patient assistance, in accordance with one or more embodiments. The platform configuration illustrated in FIG. 7 may demonstrate how the humanoid-inspired design facilitates intuitive interaction with patients and caregivers. The familiar form factor may reduce anxiety and promote acceptance while providing the functional capabilities needed for effective patient assistance operations.

As further shown in FIG. 7, the platform may incorporate a patient support surface(s) 702A positioned on the torso structure. The patient support surface may be arranged to provide contact and support for individuals during various assistance operations, including lifting and transfer procedures. These surfaces may be covered in a variety of materials, such as synthetic skin or other soft-touch materials. In some embodiments, these surfaces may further include sensors which allow the platform to detect pressures placed on the platform by the patient (e.g., persons prescribed care by the robot platform, persons assisting in the care of another while using the robot platform, etc.) which enables the platform to adjust as needed to maintain stability during navigation and/or manipulation tasks.

In various embodiments, communication system 702B can receive data from one or more patients, or other users, as well as coordinate communication between various components of the platform (e.g., to share sensor data, instructions, etc.) This data may be collected by a variety of sensors coupled to, built in, or otherwise in communication with the platform 700. For example, platform 700 can include upper body sensors 702E and lower body sensors 770. These sensors may include one or more cameras 770A, LiDAR 770B, microphone 770C, etc. Other sensors may include pressure sensors, ultrasonic sensors, infrared sensors, an IMU, etc. Although some sensors are shown as being included in lower body sensors 770, this is for illustration purposes only, and sensors may be located anywhere on the platform 700 as needed to perform its various tasks. For example, sensors related to interaction with patient can reside on the upper body of the robot, while navigation sensors can reside on lower body. The estimation of the positioning of upper body and robotic arms can be based on the positioning of the lower body.

The platform 700 may also be continuously collecting environmental data using LiDAR and user data (e.g., position, posture, etc.) using camera. In some embodiments, sensors may also be located external to the platform 700, such as in fixed positions within a known environment, attached to a patient or other users in the same environment, etc. These sensors may be in communication with the platform 700 either directly or through a user device or other device which mediates the data to the platform, such as via communication system 702B. This may enable the platform to detect environmental or patient details earlier because those details are communicated when they are first detected by any sensor, rather than when the robot platform 700 actually encounters the issue.

In some embodiments, the platform 700 may also include a task control system 702C and a navigation control system 710. In the example of FIG. 7, the task control system is responsible for manipulation tasks and is located in the upper body structure 702 and may control the shoulder joints 716 A/B and task arms 714 A/B. The navigation control system 710 can be responsible for navigating the platform though known locations to perform various tasks for patients. In this example, the navigation control system may be integrated into propulsion system 708. In various embodiments, these control systems may control more or fewer tasks than described herein, may be located at different locations within the robot, etc.

In some embodiments, the control systems can make use of a plurality of machine learning models to determine which tasks are to be performed next. These machine learning models may include neural networks, such as convolutional neural networks, recurrent neural networks, transformer-based networks, large language models, or any other suitable models. In some embodiments, the models may be hosted by a machine learning model manager 702D. The machine learning model manager 702D may be an execution environment provided by, or accessible to, the platform 700. The machine learning model manager 702D may include all of the data, libraries, etc. needed to execute the various models. Additionally, in some embodiments, the machine learning model manager 702D may be associated with dedicated hardware and/or software resources for execution of the models. In the example of FIG. 1, the machine learning model manager 702D may host a plurality of models. However, in various embodiments, each model may be associated with its own machine learning model manager, models may execute across multiple machine learning model managers, etc., depending on resource availability, model resource requirements, etc. Additionally, although the platform 700 is depicted as hosting all of the models locally in FIG. 1, in some embodiments all or some of the models may be hosted remotely (e.g., in a cloud computing environment, etc.). In such instances, the sensor data may be passed to the remote models by the platform 700, which then receives instructions back from the remote models and executes the instructions.

The chassis may comprise a structural framework that provides the foundational support for the mobile robotic platform. The chassis may be configured to support both the static weight of the platform components and the dynamic loads encountered during patient handling operations. The structural design of the chassis may balance the requirements for stability, maneuverability, and payload capacity in healthcare environments.

The chassis may incorporate a wheel arrangement that enables navigation across various indoor surfaces while maintaining stability during operation. The wheels may be positioned to provide a stable base that resists tipping forces that may occur during patient lifting and transfer operations. The wheel configuration may allow for omnidirectional movement capabilities while maintaining sufficient ground contact for load distribution.

The chassis may feature an A-frame geometry that provides structural advantages for patient assistance applications. In this configuration, the chassis may comprise two leg struts that angle outward from a central mounting point. The leg struts may extend outward and downward to create a triangular or A-shaped base structure when viewed from the front or rear of the platform.

The A-frame geometry may position wheels at the ends of the leg struts, creating a wide wheelbase that enhances stability during lifting operations. This arrangement may distribute the weight of the platform and any supported payload across multiple contact points with the ground surface. The angled leg struts may provide structural rigidity while allowing for a compact central mounting area for the torso structure.

The outward angling of the leg struts may create a stable foundation that resists overturning moments that may occur when the platform supports patient weight or performs lifting motions. The geometry may provide a low center of gravity for the chassis while maintaining sufficient ground clearance for navigation over typical indoor surfaces and obstacles.

The A-frame configuration may enable the chassis to maintain stability even when subjected to lateral forces or uneven weight distribution that may occur during patient interaction. The structural arrangement may distribute loads through the leg struts to the wheel contact points, providing a stable platform for the upper body components to operate from.

The chassis geometry may facilitate approach angles that allow the platform to position close to patients while maintaining stability. The A-frame structure may provide clearance for the platform to approach beds, chairs, and other furniture commonly found in healthcare environments while maintaining the structural integrity needed for safe patient handling operations.

The torso structure may provide the primary framework for the upper body portion of the mobile robotic platform. The torso structure may be configured to house various components while presenting a form factor that facilitates interaction with patients and healthcare staff. The torso structure may serve as a mounting platform for robotic arms, sensing systems, and patient support surfaces.

The patient support surface may be implemented in various configurations to accommodate different patient needs and comfort requirements during assistance operations. The patient support surface may be positioned on the torso structure to provide contact and support for individuals during lifting, sit to stand, and transfer procedures.

A rigid padded plate implementation may provide a stable and supportive surface for chest and head contact during lifting operations. The rigid padded plate may comprise a structural backing element that maintains its shape under load while providing a firm contact surface for patient support. The padding may be applied to the contact surface of the rigid plate to enhance patient comfort while maintaining the structural integrity needed for load-bearing operations.

The rigid padded plate configuration may distribute patient weight across a defined contact area, providing consistent support during lifting and transfer procedures. The rigid structure may resist deformation under load, which may help maintain proper patient positioning and support throughout the assistance operation. The padding layer may provide cushioning to reduce pressure points and enhance patient comfort during contact with the support surface.

An articulated surface implementation may provide angular adjustment capability to accommodate different patient positions and comfort preferences. The articulated surface may comprise multiple segments or panels that can be adjusted relative to each other to conform to patient body contours or to optimize contact angles during assistance operations. The articulation mechanism may enable adjustment of the surface geometry to match patient anatomy or to provide optimal support angles for different types of assistance procedures.

The articulated surface may include hinge points or pivot mechanisms that allow sections of the support surface to be positioned at different angles. This adjustability may enable the platform to accommodate patients of different sizes or to optimize the contact surface for specific assistance scenarios. The articulation capability may allow the support surface to conform to patient body shapes while maintaining adequate support for lifting and transfer operations.

A flexible foam implementation may provide enhanced comfort through conformable contact surfaces. The flexible foam material may compress and deform under patient contact to distribute pressure more evenly across the contact area. The foam material may provide cushioning that adapts to patient body contours while maintaining sufficient support for assistance operations.

The flexible foam configuration may comprise materials with specific compression characteristics that provide appropriate support while enhancing patient comfort. The foam material may be selected to provide a balance between comfort and structural support, ensuring that the surface can accommodate patient weight while providing a comfortable contact experience.

An inflatable material implementation may provide adjustable firmness and conformability for patient support applications. The inflatable material may be configured to allow adjustment of internal pressure to modify the firmness and support characteristics of the patient support surface. The inflatable configuration may enable customization of the support surface properties for different patients or assistance scenarios.

The inflatable material may comprise chambers or bladders that can be inflated to different pressures to provide varying levels of support and comfort. The inflation system may allow real-time adjustment of the support surface characteristics during assistance operations to optimize patient comfort and support effectiveness.

A hybrid assembly implementation may combine the benefits of rigid structural support with soft contact surfaces for patient comfort. The hybrid assembly may include a rigid backing plate that provides structural integrity and load-bearing capability coupled to a soft or flexible surface contact layer that enhances patient comfort during contact operations.

The rigid backing plate of the hybrid assembly may provide the structural foundation needed to support patient weight and resist deformation during lifting operations. The backing plate may maintain the overall shape and position of the support surface while distributing loads to the torso structure mounting points.

The soft or flexible surface contact layer of the hybrid assembly may be positioned on the patient-facing side of the rigid backing plate to provide comfortable contact during assistance operations. The soft contact layer may comprise foam, fabric, or other cushioning materials that provide pressure distribution and comfort enhancement while allowing the underlying rigid structure to provide the necessary support capability.

The coupling between the rigid backing plate and the soft contact layer may be configured to maintain the integrity of both components during patient assistance operations. The coupling may allow the soft layer to provide comfort benefits while ensuring that loads are properly transferred to the rigid backing structure for safe and effective patient support.

The robotic arms may extend from the torso structure to provide manipulation capabilities for patient assistance operations. The robotic arms may be positioned on opposing sides of the torso structure and may be configured to perform various handling and support functions during patient interaction procedures. Each robotic arm may comprise multiple segments connected by articulated joints that enable controlled movement and positioning.

Each robotic arm may include at least three degrees of freedom to provide the range of motion needed for patient assistance tasks. The degrees of freedom may be distributed across multiple joints within each arm, allowing for complex positioning and movement patterns that can accommodate different patient sizes and assistance scenarios. The articulation capability may enable the robotic arms to reach various positions around patients while maintaining appropriate support angles and contact forces. In some embodiments, by automatically adjusting the shoulder width, the robot can afford an arm with fewer degrees of freedom.

The robotic arms may be mounted to a lateral positioning mechanism that enables adjustment of the effective shoulder width of the platform. The lateral positioning mechanism may be configured to move the robotic arms outward or inward in a horizontal direction to accommodate different patient sizes and body shapes. This adjustment capability may allow the platform to optimize arm positioning for individual patients while maintaining proper support geometry during assistance operations.

Each robotic arm may comprise a linear actuator that enables translation of the arm mounting point relative to the torso structure. The linear actuator may provide controlled movement of the entire robotic arm assembly along a horizontal axis, allowing for precise positioning of the shoulder width between the arms. The linear actuator configuration may enable the platform to adapt to patients with different body dimensions while maintaining symmetric arm positioning.

The lateral positioning mechanism may be configured to automatically adjust shoulder width based on measurements captured by sensing systems integrated into the platform. The adjustment process may utilize data from cameras or other sensors to determine optimal arm spacing for individual patients. The automatic adjustment capability may enable the platform to customize its configuration for each patient interaction without requiring manual intervention from healthcare staff.

The shoulder width adjustment may also be based on stability measurements of the platform as patients lean against the robot during assistance operations. The platform may monitor stability parameters and adjust arm positioning to maintain optimal balance and support characteristics as patient weight is transferred to the platform. This dynamic adjustment capability may enhance safety and effectiveness during patient handling procedures.

The robotic arms may incorporate a sling system for supporting patients from underneath the arms during lifting operations. The sling system may provide a secure and comfortable method for supporting patient weight while allowing the robotic arms to control the lifting and transfer process. The sling configuration may distribute patient weight across the arm structures while maintaining patient comfort and safety during assistance procedures.

The sling system may be configured to engage with patients in a manner that provides secure support while allowing for controlled movement during lifting and transfer operations. The sling may be positioned to support patients from underneath their arms, creating a stable support configuration that enables the robotic arms to safely lift and move individuals. The sling arrangement may accommodate patients with different mobility levels and physical capabilities.

Additional cameras may be mounted at the wrist of each robotic arm to provide enhanced visibility during patient transfer operations. The wrist-mounted cameras may be positioned to capture visual information from the perspective of the robotic arms, providing detailed views of patient contact areas and manipulation zones. These cameras may supplement the primary sensing systems of the platform by providing close-range visual feedback during patient handling procedures.

The wrist-mounted cameras may be particularly valuable during patient transfer operations when the primary cameras on the chassis may experience occlusion due to patient positioning. The wrist-mounted cameras may maintain visibility of the patient and surrounding environment even when patients are positioned against the torso structure of the platform. This enhanced visibility may enable more precise control of patient handling operations and may improve safety during complex transfer procedures.

The wrist-mounted cameras may provide visual feedback that enables the platform to monitor patient positioning and contact forces during assistance operations. The cameras may capture images that allow the control system to assess patient comfort and safety while adjusting arm positioning and support forces as needed. The visual information from the wrist-mounted cameras may be integrated with other sensor data to provide comprehensive monitoring of patient assistance operations. Other cameras may also be added to various positions depending on the intended operations of the platform. For example, in addition to a front camera, and wrist cameras, other cameras may include a back (reverse) camera, a low mounted camera (e.g., closer to the floor, below a payload, etc.), a high mounted camera (e.g., closer to the top of the robot, above a payload, etc.). In some embodiments, not all cameras may be active at once, they may be activated based on occlusion (e.g., if the patient blocks a camera while being carried, then one or more additional cameras may be activated to continue navigation operations, etc.).

The combination of articulated robotic arms, adjustable shoulder width, sling support systems, and wrist-mounted cameras may provide a comprehensive manipulation system for patient assistance applications. The integrated arm configuration may enable the platform to perform complex patient handling tasks while maintaining safety and comfort throughout the assistance process.

The mobile robotic platform may incorporate additional support structures that enhance patient stability and safety during assistance operations. These supplementary support elements may work in conjunction with the primary support systems to provide comprehensive patient handling capabilities across various assistance scenarios.

A foot support may be integrated into the platform to provide additional stability for patients during lifting and transfer operations. The foot support may be positioned to engage with patient feet or lower legs, creating a stable base that helps maintain patient positioning during assistance procedures. The foot support may prevent patient feet from sliding or shifting during lifting operations, which may enhance safety and comfort throughout the assistance process.

The foot support may be configured to accommodate patients in various positions, including seated and standing configurations. The support structure may be adjustable to match different patient heights and leg lengths, ensuring proper contact and support regardless of individual patient dimensions. The foot support may provide a stable platform that patients can rest against while the robotic arms and torso structure provide upper body support during lifting operations.

A knee support may be incorporated into the platform to provide additional stabilization for patients during assistance procedures. The knee support may be positioned to contact and support patient knees or lower thighs, creating an additional point of contact that helps maintain proper patient alignment during lifting and transfer operations. The knee support may work in coordination with other support elements to distribute patient weight and provide comprehensive stability.

The knee support may be adjustable to accommodate different patient sizes and mobility levels. The support structure may be positioned at appropriate heights and angles to provide comfortable contact while maintaining effective support during assistance operations. The knee support may help prevent patient legs from buckling or shifting during lifting procedures, contributing to overall safety and effectiveness of the assistance process.

In some cases, the platform may incorporate both foot and knee support elements that work together to provide comprehensive lower body stabilization. The combined support system may create multiple contact points that help maintain patient positioning and stability throughout various assistance procedures. The coordinated support elements may distribute forces and provide redundant stabilization to enhance patient safety during lifting and transfer operations.

The platform may include a communication screen that enables interaction between the robotic system and patients or healthcare staff. The communication screen may be positioned on the torso structure at a location that provides clear visibility for users during operation. The screen may display information, instructions, or interface elements that facilitate communication and coordination during patient assistance procedures.

The communication screen may present visual information that helps patients understand the assistance process and may provide feedback about the status of ongoing operations. The screen may display simple graphics, text messages, or interface elements that communicate the current state of the platform and any actions that patients or staff may need to take. The visual communication capability may help reduce anxiety and promote cooperation during assistance procedures.

The screen may be configured to display a simple face interface that provides a familiar and reassuring visual element for patient interaction. The face interface may help humanize the robotic platform and may make the assistance experience more comfortable for patients who may be apprehensive about robotic assistance. The face display may include expressions or animations that correspond to different operational states or assistance phases.

The communication screen may also serve as an input interface that allows healthcare staff or patients to provide commands or preferences to the robotic platform. The screen may include touch-sensitive areas or virtual buttons that enable users to select assistance options, adjust settings, or control specific aspects of the assistance process. The interactive capability may provide a user-friendly method for customizing assistance operations to meet individual patient needs.

The platform may incorporate a head structure that provides additional functionality and adaptability for patient assistance applications. The head structure may be positioned at the upper portion of the torso structure and may serve multiple functions depending on the configuration and operational requirements of the assistance scenario.

The head structure may be reconfigurable to provide a patient support surface when needed for specific assistance operations. The reconfiguration capability may enable the head structure to be adapted from its standard configuration into a support element that can contact and support patients during lifting or transfer procedures. This adaptability may provide additional support options for complex assistance scenarios or for patients with specific support requirements.

The head structure may be reconfigured through removal from its standard mounting position. In this configuration, the head structure may be detached from the torso structure and repositioned or replaced with alternative support elements as needed for specific assistance operations. The removable configuration may provide flexibility in adapting the platform for different types of patient assistance procedures.

The head structure may be reconfigured through rotation relative to its mounting point on the torso structure. The rotational capability may enable the head structure to be repositioned to different orientations that provide optimal support angles or contact surfaces for patient assistance operations. The rotation mechanism may allow the head structure to be adjusted without complete removal from the platform.

The head structure may be reconfigured through folding mechanisms that change the shape or orientation of the structure. The folding capability may enable the head structure to be collapsed, extended, or reshaped to provide different support configurations as needed for various assistance scenarios. The folding mechanism may provide a compact method for adapting the head structure without requiring removal or complex repositioning procedures.

The reconfigurable head structure may provide additional patient contact surfaces that supplement the primary patient support surface on the torso structure. The additional support capability may be particularly valuable for patients who require multiple contact points or specialized support configurations during assistance operations. The head structure reconfiguration may enable the platform to adapt to unique patient needs or complex assistance scenarios that may not be adequately addressed by the standard support configuration.

The combination of supplementary support structures, communication interfaces, and reconfigurable elements may enhance the overall capability and adaptability of the mobile robotic platform for patient assistance applications. These additional elements may work together with the primary platform systems to provide comprehensive and customizable assistance solutions for healthcare environments.

The mobile robotic platform may incorporate a control system that manages the coordination and operation of the various platform subsystems during patient assistance procedures. The control system may be configured to process sensor inputs, coordinate actuator movements, and manage user interactions to provide safe and effective patient handling capabilities. The control system architecture may integrate multiple processing elements and interface systems to enable autonomous operation while maintaining appropriate levels of human supervision.

The control system may be configured to autonomously control navigation and manipulation tasks of the robotic platform. The autonomous control capability may enable the platform to perform patient assistance operations with reduced manual intervention from healthcare staff. The control system may coordinate the movement of the chassis, positioning of the torso structure through the waist joint, and operation of the robotic arms to execute complex assistance procedures.

The platform may incorporate a multimodal user interface that integrates speech, vision, and gesture understanding capabilities to provide natural and intuitive interaction between the robotic system and human users. The multimodal interface may enable healthcare staff and patients to communicate with the platform using familiar interaction methods that do not require specialized training or technical expertise.

The speech understanding component of the multimodal interface may be configured to recognize and interpret verbal commands from healthcare staff or patients. The speech recognition system may process spoken instructions and translate them into control commands that direct the operation of the platform. The speech interface may enable users to provide high-level instructions such as assistance type selection, positioning commands, or operational preferences through natural language communication.

The speech understanding system may be configured to recognize commands from multiple users, including both patients and healthcare staff members. The system may be able to distinguish between different types of users and may respond appropriately to commands based on the authority level or role of the person providing the instruction. The speech interface may provide confirmation feedback to ensure that commands have been properly understood before executing assistance operations.

The vision understanding component of the multimodal interface may utilize camera systems integrated into the platform to interpret visual cues and gestures from human users. The vision system may analyze body language, hand gestures, and facial expressions to understand user intentions and preferences during assistance operations. The visual interpretation capability may supplement verbal communication and may provide additional context for understanding user needs.

The gesture understanding system may recognize specific hand movements or body positions that correspond to predefined commands or preferences. Healthcare staff may use standardized gestures to direct platform operations or to indicate specific assistance requirements for individual patients. The gesture recognition capability may provide a silent communication method that can be used in situations where verbal communication may not be appropriate or practical.

The vision system may also monitor patient positioning and comfort levels during assistance operations by analyzing facial expressions and body language. The visual monitoring capability may enable the control system to adjust assistance parameters in real-time based on patient responses and comfort indicators. The vision-based feedback may help ensure that assistance operations are performed in a manner that maintains patient comfort and safety throughout the procedure.

The integration of speech, vision, and gesture understanding may create a comprehensive communication interface that accommodates different user preferences and operational scenarios. The multimodal approach may provide redundant communication pathways that ensure reliable interaction even when individual interface components may be compromised by environmental conditions or user limitations.

The robotic platform may be configured to operate in a hands-free mode that enables human operators to supervise and provide commands without requiring physical contact with the platform. The hands-free operation mode may allow healthcare staff to maintain oversight of assistance operations while avoiding the physical strain associated with manual patient handling procedures.

In the hands-free operation mode, human operators may provide verbal commands to direct platform movements and assistance operations. The operators may use voice commands to instruct the platform to approach patients, adjust positioning, initiate lifting procedures, or modify assistance parameters as needed. The verbal command interface may enable operators to maintain control over assistance operations while remaining at a safe distance from the platform and patient.

The hands-free mode may enable operators to supervise multiple aspects of the assistance operation simultaneously without requiring direct physical interaction with the platform controls. Operators may monitor patient comfort, platform positioning, environmental conditions, and assistance progress while providing corrective commands through the speech interface as needed. The supervisory capability may allow experienced healthcare staff to oversee assistance operations while maintaining the flexibility to intervene when necessary.

The platform may be configured to provide audio feedback to operators during hands-free operation to confirm command reception and provide status updates about ongoing assistance procedures. The audio feedback system may announce the current operational state, confirm received commands, and alert operators to any conditions that may require attention or intervention. The audio communication may enable operators to maintain awareness of platform status without requiring visual monitoring of display interfaces.

The hands-free operation mode may include safety protocols that require operator confirmation before executing potentially hazardous operations. The platform may request verbal confirmation from operators before initiating patient lifting procedures or making significant changes to assistance parameters. The confirmation protocols may ensure that operators maintain active oversight of assistance operations even when not physically interacting with platform controls.

The control system may be configured to distinguish between different types of verbal commands and may respond appropriately based on the urgency or priority of the instruction. Emergency stop commands may receive immediate response and may override other operational instructions to ensure patient and operator safety. Routine operational commands may be processed through normal command queues while maintaining appropriate response times for effective assistance operations.

The hands-free operation capability may be particularly valuable in healthcare environments where operators may need to maintain sterile conditions or may have limited mobility due to other patient care responsibilities. The verbal command interface may enable operators to direct platform operations while attending to other tasks or while positioned at locations that provide optimal oversight of the assistance procedure.

The combination of multimodal interface capabilities and hands-free operation modes may provide a flexible and intuitive control system that accommodates various operational scenarios and user preferences. The integrated interface system may enable effective human-robot collaboration while maintaining the safety and effectiveness needed for patient assistance applications in healthcare environments.

The mobile robotic platform may be configured in operational positions that enable effective patient assistance across various healthcare scenarios. The platform may be positioned to demonstrate readiness for patient lifting operations, with the torso structure pitched forward relative to the chassis to facilitate patient approach and contact. The robotic arms may extend outward and downward in a configuration that enables support of patients from underneath their arms during lifting procedures.

In some embodiments, the chassis may be positioned to move close to patients while maintaining stability, and the torso structure may pitch to accommodate body contact and weight transfer during assistance operations. The coordinated positioning of the chassis and torso structure may enable the platform to adapt to different patient positions and assistance requirements.

The platform may be configured to perform sit to stand assistance operations where patients transition from seated to standing positions with robotic support. During sit to stand procedures, the platform may position the patient support surface against the patient's chest while the robotic arms provide additional stabilization and lifting assistance. The waist joint may enable the torso structure to adjust its angle throughout the assistance process to maintain optimal contact and support as the patient transitions between positions.

The platform may also be configured to perform stand to sit assistance operations that help patients transition from standing to seated positions in a controlled manner. The stand to sit procedure may involve the platform providing support and guidance as patients lower themselves into chairs or other seating arrangements. The robotic arms and patient support surface may work together to control the descent rate and maintain patient stability throughout the seating process.

In some embodiments, the platform may be configured for lift and transfer operations that involve picking up patients and moving them between different locations within healthcare or home environments. The lift and transfer capability may enable the platform to support the full body weight of patients while transporting them from beds to wheelchairs, between different seating arrangements, or to other locations as needed for patient care procedures.

The lift and transfer operations may require the platform to support substantial payload capacities while maintaining stability and safety throughout the transfer process. The platform may be designed with a payload capacity of up to 350 pounds to accommodate a wide range of patient sizes and weights. The 350-pound capacity may enable the platform to safely lift and transfer most patients encountered in healthcare environments while maintaining appropriate safety margins for reliable operation. In some embodiments, the payload capacity may be increased or decreased depending on, e.g., expected or known patient size, the payload capacity of other robot platforms already deployed to a customer site, etc.

The payload capacity may be achieved through the coordinated design of the chassis, waist joint, torso structure, and robotic arms working together to distribute patient weight and provide stable support during lifting operations. The A-frame chassis geometry may contribute to the payload capability by providing a stable base that resists tipping forces when supporting substantial loads. The dual motor configuration of the waist joint may provide the torque needed to control torso positioning while supporting patient weight.

With continued reference to FIG. 6, the platform may be configured to perform bed repositioning operations for patients who cannot get off their bed. The bed repositioning capability may address the need to reposition patients periodically to prevent bed sores and maintain patient comfort during extended bed rest periods. The bed repositioning operations may involve the platform approaching patients who are lying in bed and providing assistance to turn them from one side to another.

The bed repositioning operations may be performed multiple times throughout the day to maintain proper patient care protocols. In some cases, bed repositioning may be required every couple of hours for patients with limited mobility, which may result in numerous turning procedures per day for individual patients. The robotic assistance for bed repositioning may reduce the physical burden on healthcare staff while ensuring consistent and timely execution of patient repositioning procedures.

The platform may approach patients in bed configurations and use the robotic arms to provide controlled support and movement assistance during turning procedures. The robotic arms may be positioned to support patient body segments while coordinating movement to achieve the desired repositioning. The patient support surface may provide additional contact and stability during bed repositioning operations to ensure patient comfort and safety throughout the procedure.

The bed repositioning capability may utilize the articulated movement of the robotic arms and the pitching motion of the torso structure to provide the range of motion needed for effective patient repositioning. The waist joint may enable the torso structure to adjust its angle to optimize access to patients in bed while maintaining appropriate support angles during turning procedures. The lateral positioning mechanism may adjust the shoulder width of the robotic arms to accommodate different bed configurations and patient sizes during turning operations.

The platform may coordinate the bed repositioning operations through integration of the control system with the perception systems to monitor patient positioning and comfort throughout the turning procedure. The sensing systems may provide feedback about patient response and positioning to ensure that turning operations are performed safely and effectively. The control system may adjust the speed and force of turning movements based on patient feedback and comfort indicators detected through the perception systems.

The combination of lift and transfer capabilities and bed repositioning operations may provide comprehensive patient handling functionality that addresses multiple aspects of patient care in healthcare environments. The platform may transition between different operational modes based on the specific assistance requirements for individual patients and care scenarios. The 250-pound payload capacity may ensure that the platform can perform both transfer and turning operations safely across a broad range of patient populations encountered in healthcare facilities.

The mobile robotic platform may achieve effective patient assistance through coordinated operation of multiple subsystems that work together to provide safe and reliable healthcare support. The integration of navigation, manipulation, perception, and control systems may enable the platform to perform complex patient handling tasks while maintaining stability and safety throughout assistance operations.

The chassis navigation system may coordinate with the torso positioning mechanism to enable optimal approach angles for patient interaction. During patient assistance operations, the chassis may navigate to position the platform at appropriate distances and orientations relative to patients while the waist joint adjusts the torso structure angle to facilitate contact and support. The navigation system may utilize sensor feedback to maintain precise positioning while the torso structure pitches forward or backward to accommodate different patient positions and assistance requirements.

The coordination between chassis movement and torso positioning may enable the platform to adapt to various patient configurations without compromising stability or safety. The chassis may move closer to patients while the torso structure leans forward to establish contact, or the chassis may maintain distance while the torso structure adjusts to provide optimal support angles. The integrated movement capability may allow the platform to customize its approach for individual patients and specific assistance scenarios.

The robotic arm manipulation system may work in coordination with both the chassis navigation and torso positioning to provide comprehensive patient support during assistance operations. The arms may extend and position themselves based on the overall platform configuration established by the chassis and torso positioning. The lateral positioning mechanism may adjust arm spacing while the chassis and torso establish the primary platform orientation, creating a coordinated approach that optimizes patient contact and support.

The perception system integration may provide continuous feedback that enables real-time coordination between all platform subsystems during patient assistance operations. The sensor fusion capability may combine data from multiple sensing modalities to provide comprehensive environmental awareness that informs navigation decisions, torso positioning, and arm manipulation simultaneously. The integrated perception feedback may enable the platform to adjust all subsystems in response to changing conditions or patient responses during assistance procedures.

The hierarchical sensor weighting system may prioritize different perception inputs based on the current operational phase of patient assistance. During navigation phases, the LiDAR sensor may receive primary priority for environmental mapping and obstacle avoidance while the chassis positioning system utilizes this information for path planning and movement control. During manipulation phases, the depth cameras may receive primary priority for patient positioning and contact monitoring while the robotic arms adjust their configuration based on visual feedback.

The tactile sensing integration may provide the highest priority feedback during direct patient contact phases of assistance operations. The electronic skin panels may monitor contact forces and pressure distribution while all other platform subsystems adjust their operation to maintain safe interaction parameters. The control system may coordinate chassis stability, torso positioning, and arm manipulation based on tactile feedback to ensure that patient contact remains within safe force limits throughout assistance procedures.

The control system architecture may manage the temporal coordination of subsystem operations to ensure smooth and effective assistance procedures. The control system may sequence chassis navigation, torso positioning, and arm manipulation to create coordinated movement patterns that optimize patient comfort and safety. The sequencing capability may enable the platform to perform complex assistance operations through coordinated execution of multiple subsystem actions.

The transition between operational modes may involve coordinated reconfiguration of multiple platform subsystems based on proximity thresholds and task requirements. The platform may transition from navigation mode to manipulation mode by coordinating chassis positioning, torso angle adjustment, and arm extension in a synchronized manner. The mode transition capability may enable seamless operation as the platform moves between different phases of patient assistance procedures.

The compliance envelope maintenance may require continuous coordination between perception systems and all actuated platform components. The control system may monitor tactile feedback and adjust chassis positioning, torso angle, and arm forces simultaneously to maintain safe interaction parameters. The compliance coordination may ensure that patient contact forces remain within acceptable limits while maintaining effective assistance capability across all platform subsystems.

The environmental adaptation capability may involve coordinated adjustment of multiple platform subsystems based on workspace geometry and patient positioning. The lateral positioning mechanism may adjust arm spacing while the chassis navigation system adapts to aisle width constraints and the torso positioning system accommodates patient height and positioning requirements. The coordinated adaptation may enable the platform to operate effectively in various healthcare environments while maintaining optimal patient assistance capability.

The sensor fusion module may integrate data streams from all perception systems to provide unified environmental awareness that informs coordinated subsystem operation. The fusion process may combine LiDAR mapping data, depth camera patient monitoring, ultrasonic proximity detection, and tactile force feedback to create comprehensive situational awareness. The integrated perception capability may enable coordinated response to environmental changes and patient needs across all platform subsystems.

The safety monitoring integration may coordinate emergency response capabilities across all platform subsystems to ensure rapid and effective response to hazardous conditions. The control system may coordinate immediate cessation of chassis movement, torso positioning, and arm manipulation in response to safety alerts from any perception system. The coordinated safety response may ensure that all platform subsystems work together to protect patients and healthcare staff during emergency situations.

The user interface integration may coordinate feedback and control capabilities across multiple platform subsystems to provide unified interaction experiences for healthcare staff and patients. The multimodal interface may accept commands that affect chassis navigation, torso positioning, and arm manipulation simultaneously while providing coordinated feedback about the status of all subsystems. The integrated interface capability may enable intuitive control of complex assistance operations through simplified user interactions.

The operational sequencing coordination may enable the platform to perform complex assistance procedures through orchestrated execution of subsystem capabilities. The platform may coordinate chassis approach movements with torso positioning and arm extension to establish patient contact, followed by coordinated lifting movements that involve chassis stabilization, torso angle adjustment, and arm manipulation working together to provide safe and effective patient support throughout the assistance procedure.

### Robot Architecture

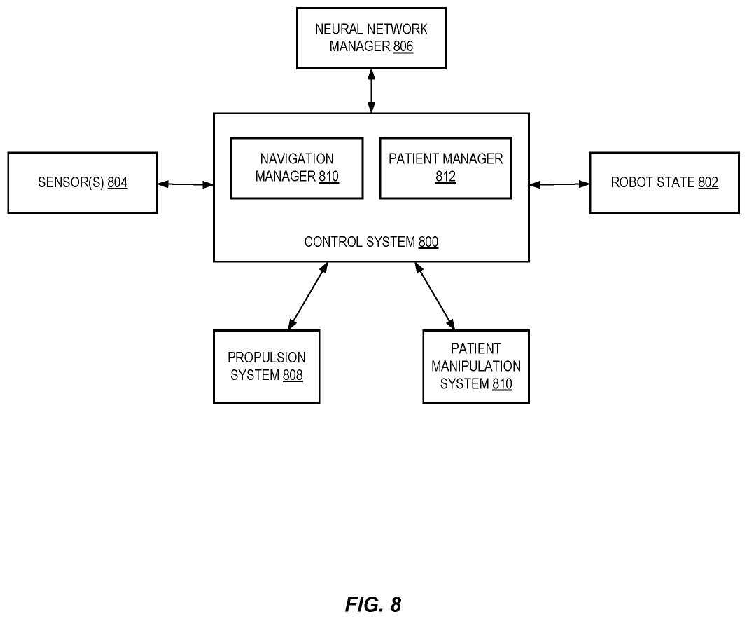

FIG. 8 depicts a control system for a mobile robotic platform, in accordance with one or more embodiments. As shown in FIG. 8, a control system 800 can use information received from various other systems to control the mobile robotic platform. For example, the control system 800 can receive information representing the current robot state 802 (e.g., position, velocity, attitude, etc. of the robot or components thereof) along with sensor data collected by sensors 804, analyses from one or more neural networks 806, etc. and generate control signals to change the robot state via commands made to the propulsion system 808 or patient manipulation system 810.

As shown in FIG. 8, the control system 800 can include one or more control managers: navigation manager 810 and patient manager 812. The navigation manager 810 is responsible for controlling the platform to perform navigation tasks as it maneuvers through a given space (e.g., a home, a hospital or other care facility, etc.). The patient manager 812 is responsible for controlling the platform to perform various patient manipulation tasks, such as helping a patient change state (e.g., sit to stand, stand to sit, etc.). These managers may work in tandem to steady the patient as the platform moves through space. In some embodiments, the control system 800 can be implemented as task control system and navigation control system, as discussed above.

As discussed, embodiments introduce a mobile robotic system capable of assisting a user with various mobility maneuvers, such as posture transitions, movement support, and fall prevention. Often, a user is at their highest risk of suffering a fall during a posture transition (e.g., when the user shifts from a seating to a standing position, from seated to lying down, etc.). The mobile robotic system can detect such a posture transition and aid the user prior to suffering a fall.

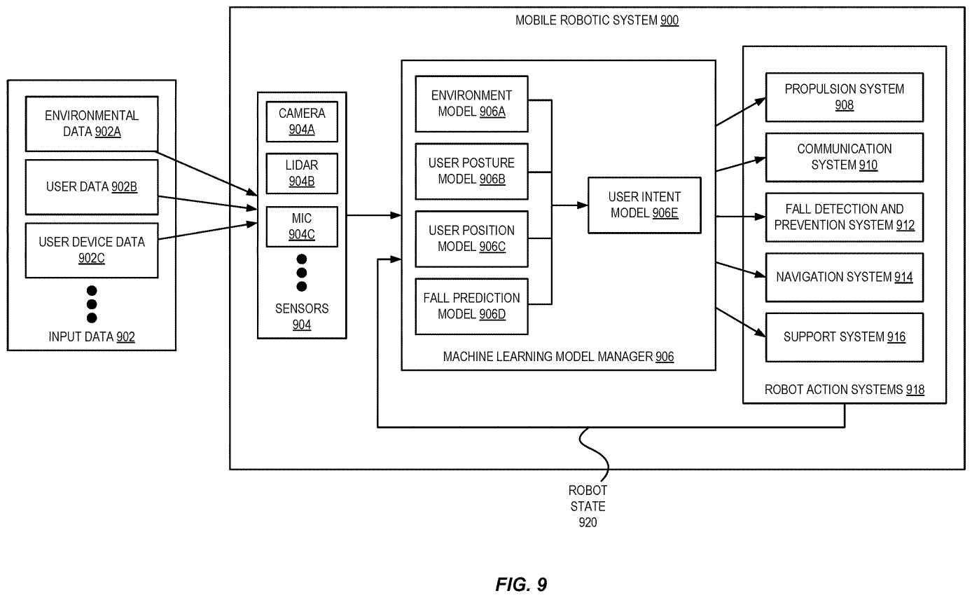

FIG. 9 illustrates a diagram of a process of autonomous robotic assistance, in accordance with one or more embodiments. As discussed, embodiments provide autonomous physical assistance to users. For example, the mobile robotic system enables end-to-end robotic support for users without requiring human caregivers. The mobile robotic system can dynamically interact with the user, adapting to their physical needs in real time. As shown in FIG. 9, the mobile robotic system 900 can receive input data 902. The input data may represent environmental data 902A, user data 902B, user device data 902C, etc. This data may be collected by a variety of sensors coupled to, built in, or otherwise in communication with mobile robotic system 900. For example, mobile robotic system 900 can include sensors 904 (e.g., one or more “sensor system(s)”) such as one or more cameras 904A, LiDAR 904B, microphone 904C, etc. Other sensors may include pressure sensors at various grip points on the mobile robotic system, an inertial measurement unit (IMU) providing attitude, direction, etc. of the mobile robotic system, a positioning sensor (e.g., a global navigation satellite system, such as GPS, Galileo, BeiDou, GLONASS, etc.), and/or other sensor(s).

Sensor data can be collected continuously, periodically, and/or on demand by the mobile robotic system 900. For example, the mobile robotic system may be activated when the user speaks a “wake word” or other call detected via microphone 904C. The mobile robotic system 900 may also be continuously collecting environmental data 902A using LiDAR 904B and user data 902B (e.g., position, posture, etc.) using camera 904A. In some embodiments, the mobile robotic system 900 may additionally receive user device data 902C. This may include commands received from an associated application executing on the user device and/or data being collected about the user by the user device. For example, the user may be able to call the mobile robotic system 900 directly using their device (e.g., entering a request through an app, etc.). Likewise, the user may be able to call the mobile robotic system 900 indirectly due to their behavior or motion. For example, the user device may detect an unsteady gait, or a gait that has been becoming more unsteady over time.

The platform may include a sensor system capable of sensing surrounding environments and scenes. Example sensors include LiDAR, depth cameras, RGB cameras, inertial measurement units, wheel odometry sensors, force/torque sensors, proximity sensors, microphones, and tactile sensing elements. The control system may use data collected by the sensor system to perform mapping, navigation, manipulation planning, patient identification, and safety monitoring. In some embodiments, one or more patient support surfaces include tactile sensors, and the control system uses data from the tactile sensors to generate real-time pressure maps that indicate contact distribution during patient manipulation tasks.

In certain implementations, the control system fuses sensor data from multiple sensors using a sensor fusion module. The fusion module may apply hierarchical weighting to sensor streams depending on the operational context and/or range to relevant objects. For example, a LiDAR sensor (e.g., bottom-mounted) may be assigned primary priority for global navigation and obstacle avoidance; a depth camera (e.g., wrist-mounted) may be assigned primary priority for mid-range semantic manipulation tasks such as detecting a bed rail, wheelchair armrest, or patient pose; and tactile sensing elements may be assigned primary priority for near-contact and contact safety control. Based at least on tactile sensor signals, the control system may maintain a compliance envelope that limits manipulator motion and/or applied forces to avoid excessive contact forces during human interaction.

As shown in FIG. 9, the sensor data may be received as input to a plurality of machine learning models. These machine learning models may include neural networks, such as convolutional neural networks, recurrent neural networks, transformer-based networks, large language models, or any other suitable models. In some embodiments, the models may be hosted by a machine learning model manager 906. The machine learning model manager 906 may be an execution environment provided by, or accessible to, the mobile robotic system 900. The machine learning model manager 906 may include all of the data, libraries, etc. needed to execute the various models. Additionally, in some embodiments, the machine learning model manager 906 may be associated with dedicated hardware and/or software resources for execution of the models. In the example of FIG. 9, the machine learning model manager 906 may host a plurality of models. However, in various embodiments, each model may be associated with its own machine learning model manager, models may execute across multiple machine learning model managers, etc., depending on resource availability, model resource requirements, etc. Additionally, although the mobile robotic system 900 is depicted as hosting all of the models locally in FIG. 9, in some embodiments all or some of the models may be hosted remotely (e.g., in a cloud computing environment, etc.). In such instances, the sensor data may be passed to the remote models by the mobile robotic system 900, which then receives instructions back from the remote models and executes the instructions.

The mobile robotic system 900 leverages AI models to analyze user speech, visual cues, body language, and posture in real-time. By synthesizing inputs from voice commands, vision sensors, and physical interactions, the robot determines the user's needs and how to physically assist them effectively. For example, in some embodiments, an ensemble of models may be used to determine user intent, with each model analyzing a different type or combination of sensor data. For example, the models may include an environment model 906A, a user posture model 906B, a user position model 906C, and a fall prediction model 906D. The outputs of these models may be received by a user intent model 906E which then generates instructions to be executed by the mobile robotic system′ action systems 918, including propulsion system 908, communication system 910, fall detection and prevention system 912, navigation system 914, and support system 916.

For example, the models enable context-aware navigation in complex indoor environments. The mobile robotic system 900 can operate efficiently in indoor environments, such as hospitals, eldercare facilities, and homes, using AI to navigate and adapt to changing, unmapped, or cluttered environments. These environments present a navigation challenge as there are typically few rules for how people and objects within the environment behave (in contrast to driving scenarios, where roads present a structured and rule-dependent navigation problem).

In some embodiments, the mobile robotic system 900 can be summoned by the user explicitly or implicitly. For example, the user may send an explicit request for the mobile robotic system using their device, via a voice command, etc. In such instances, the mobile robotic system can then determine a position of the user using user position model 906C and determine an appropriate path to the user using environment model 906A. The path can then be provided to propulsion system 908 and navigation system 914 to move the mobile robotic system to the user's position.

In some embodiments, upon arriving at the user's position, the mobile robotic system can monitor the user's posture and provide posture transition assistance. For example, the robot can detect changes in user posture, position, and/or other body language and provides mechanical support for safe body posture transitions. For example, support system 916 may extend one or more support structures to aid the user in safely completing the posture change (e.g., laying to sitting, sitting to standing, standing to walking, etc.). In some embodiments, the mobile robotic system can detect the posture changes using computer vision and/or machine learning techniques based on image data collected by the camera(s) and or LiDAR sensor(s). The support system 916 is responsible for positioning the support structures such that they can be grasped by the user or otherwise support the user during the posture change. Additionally, the support system 916 can instruct the autonomous robotic system 900 to modify its own stance to best support the user during the posture change.

As shown in various figures referenced below, the mobile robotic system can include wheeled propulsion members that may rotate around a central axis. For example, as shown at least in FIG. 6, a wheel hub motor may be connected to a leg of the mobile robotic system via two or more steering joints. In addition to steering the mobile robotic system, these steering joints allow for the repositioning of the mobile robotic system wheels to increase stability of the mobile robotic system during supportive maneuvering. This can help prevent the mobile robotic system from becoming unstable or falling over while attempting to support a user during a posture change.

In some embodiments, the mobile robotic system can assist the user with walking. For example, the mobile robotic system may include one or more support structures that enable the user to walk while leaning on the support(s). As discussed, the mobile robotic system can include pressure sensors along with motion/position sensors that enable the mobile robotic system to perform user movement intention detection and gait assistance. For example, the mobile robotic system can interpret user movements and force feedback to assist with walking, offering real-time balance support and making it easier for the user to move around confidently.

In some embodiments, the mobile robotic system also include anti-tipping mechanical support. This may include a stability mechanism to prevent tipping over during operation.

As discussed, the mobile robotic system can include a fall detection and prevention system 912. The fall detection and prevention system can use soft robotic handles with pressure sensors to detect abnormal force pressure indicative of a fall. In some embodiments, the fall detection and prevention system 912 can use vision-based and sensor-based monitoring of sudden user pose changes. This may also be used for real-time fall prevention. For example, instructions can be sent to propulsion system 908 causing an emergency braking system to stabilize the mobile robotic system and prevent user falls. Additionally, in some embodiments, the mobile robotic system can include hand and/or body strap mechanisms to catch users and mitigate impacts due to falls.

In some embodiments, communication system 910 can provide emotional and personalized interactions with the user. This may include multimodal communication methods to enhance user experience. For example, a basic mode may provide concise text-based instructions with adjustable font sizes for readability. Additionally, or alternatively, a rich mode may include a virtual agent that employs a mixture of voice commands, expressive emojis on a screen, and personalized content.

As discussed, the autonomous robotic system 900 can collect environmental and/or user data using various sensors 904. Based on the collected sensor data, the mobile robotic system 900 can predict a user's movement intent. This may include an ambulatory intent (e.g., an intent to walk in a particular direction and/or at a particular speed), a posture change intent (e.g., an intent to change positions from laying down to sitting, sitting to standing, etc.), or other intent to move or change positions. Based on the predicted intent, the mobile robotic system can then take a supportive action using its various action systems 918. When the mobile robotic system 900 takes an action, its state necessarily changes (e.g., the mobile robotic system has changed positions, entered a new room, extended and/or moved one or more supportive structures, etc.). This mobile robotic system state information 920 can be provided as feedback to the various models of machine learning model manager 906. This enables the mobile robotic system to continuously monitor the user, predict the user's movement intention, and take appropriate supportive actions based on the current state of the mobile robotic system.

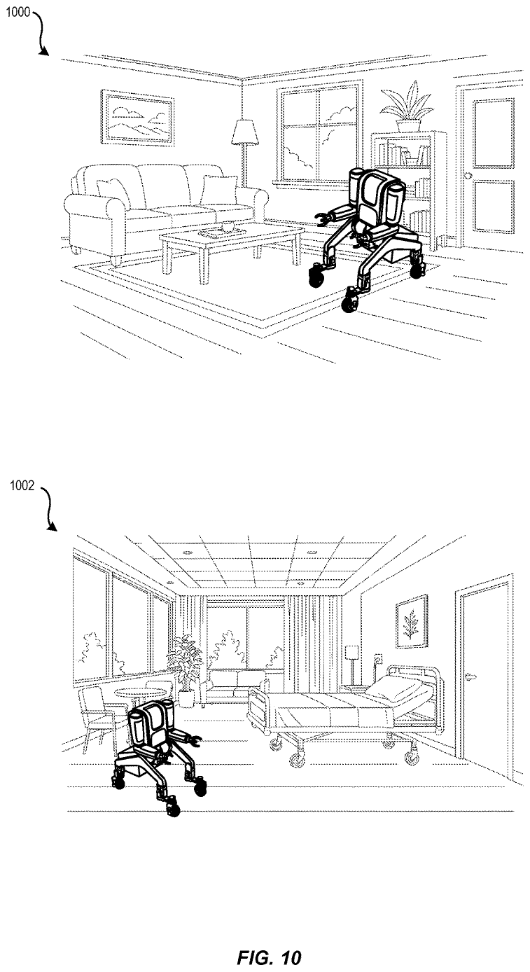

FIG. 10 depicts a mobile robotic platform deployed to patient environments 1000 and 1002, according to in accordance with one or more embodiments. Although FIG. 10 depicts a home environment 1000 and a care environment 1002 these are only examples and are not intended to be limiting. Embodiments of the mobile robotic platform may be deployed to a wide range of patient environments.

### Interactive Workflows

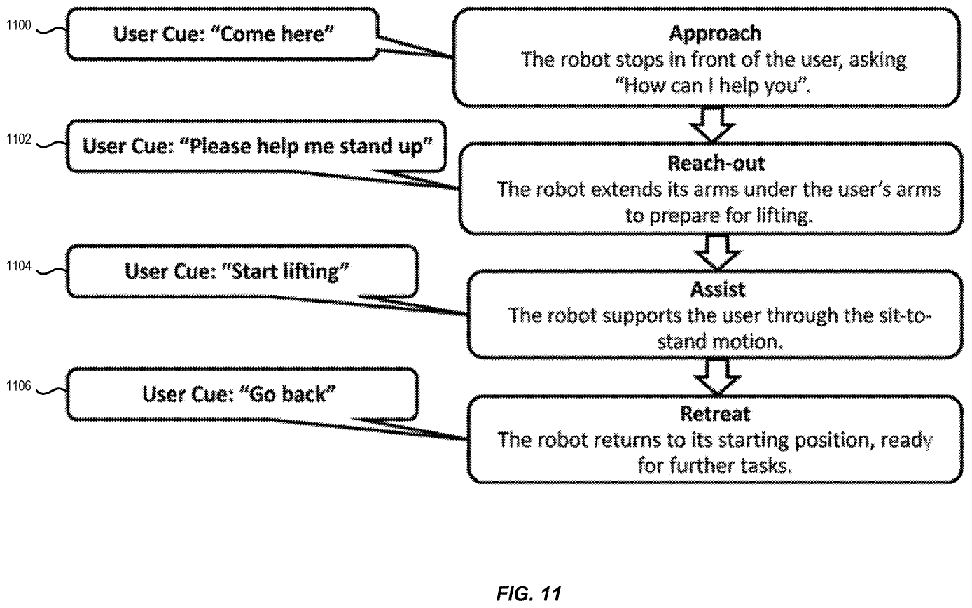

FIG. 11 illustrates a diagram of human-robot interactions for a sit to stand task in accordance with one or more embodiments. As discussed, in some embodiments, the robotic platform may perform various tasks in response to external stimuli. This may include explicit commands (e.g., received via text, voice commands, user input device, graphical user interface, or other input techniques). or implicit commands (e.g., due to detection of an imminent state change in a patient, change in platform and/or patient balance, etc.). FIG. 11 shows one example of the robotic platform performing tasks in response to user cues. Although the example of FIG. 11 shows explicit user cues, in various embodiments the user cues may alternatively be implicit. In some embodiments, implicit user cues may be identified using various machine learning methods and artificial intelligence models such as LLM to analyze patient behavior, mannerisms, body language, etc.

As shown at step 1100, a user cue of “come here” is detected. This leads the robot to change its state to approach and the robot moves to intercept the requestor. At step 1102 a new cue is received asking the platform to “please help me stand up”. After detecting this command, the robot platform can execute an assistance task. In this instance, the platform extends its arms to be under the patient's arms to prepare for lifting. At strep 1104, the next cue is to “start lifting.” The robot platform then lends support to the patient while she stands up. Once up, the patient can dismiss the robot with a “go back” cue. In some embodiments, the robot platform can return to a ready state and await the next command.

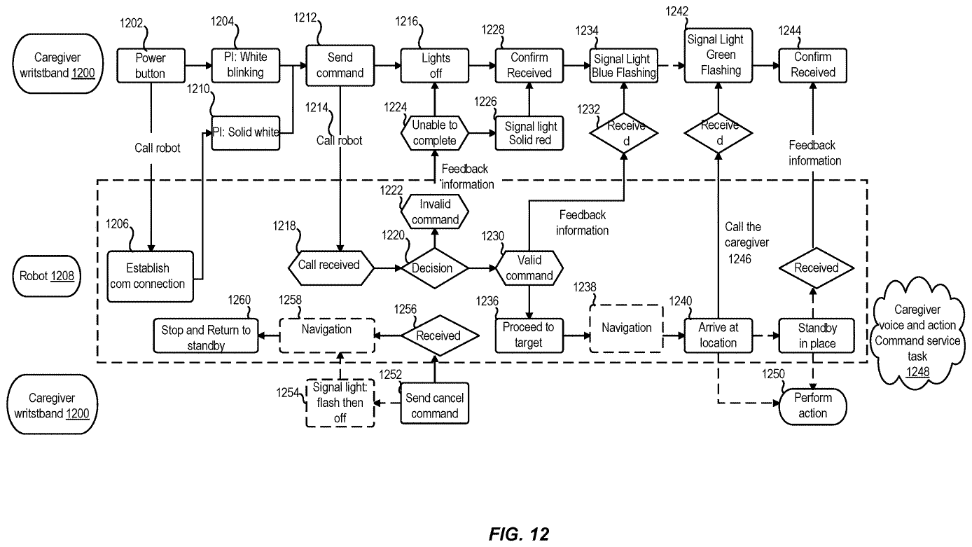

FIG. 12 illustrates an interaction logic flow between a mobile robotic platform and a caregiver wearable device (e.g., a wristband) to facilitate a coordinated assistive workflow. As discussed, embodiments of the present disclosure include a coordinated human-robot assistive workflow system designed to integrate the mobile robotic platform into existing healthcare environments, such as elder care facilities, rehabilitation centers, and hospitals, home environments, workplace environments, etc. As observed in real-world care settings, traditional manual handling of patients often requires multiple caregivers to team up and utilize significant physical force, leading to a high risk of musculoskeletal injury despite the use of back braces or manual lifting aids. Additionally, this requires a coordination of resources across multiple patients, locations, etc. to ensure that adequate staff is available at the same time to handle a given patient. Embodiments address these challenges by shifting the optimization goal of the robotic platform from mere shortest-path navigation to the minimization of caregiver wait time and the optimization of handoff latency between human and robotic agents.

In accordance with one or more embodiments, the system implements a loading zone or staging area paradigm to manage patient transfers more efficiently. In a typical care facility, high-traffic areas near beds or rehabilitation equipment can become congested. The robotic platform is configured to operate in conjunction with a designated loading zone-an area identified as having lower congestion and more room for maneuverability. Caregivers may move patients in wheelchairs to the loading zone, where the robot then takes over the heavy labor of lifting and transporting the patient across longer distances (e.g., across a room to a specific bed). This modularity allows the robot to handle the ‘heavy lifting’ and long-distance transport, while the caregiver is freed to perform higher-value clinical tasks.

To facilitate this coordination, the system utilizes a specialized communication protocol and associated wearable devices. As shown in the interaction logic, a caregiver may be equipped with a wearable communication device, such as a wristband or bracelet. This device serves as a multimodal interface for two-way communication between the caregiver and one or more robotic platforms. The wearable device may include physical input buttons (e.g., a ‘Call’ button and a ‘Confirm/Action’ button), voice activation capabilities, and output mechanisms such as vibration motors, multi-color LED signal indicators (e.g., blue, green, and red), and speakers for audio feedback.

A typical workflow initiation begins with a caregiver request. The caregiver, standing near a patient, activates a call command via the wearable device. In some embodiments, the robotic platform utilizes vision-based intelligence to localize the caregiver and confirm their intention. Upon receiving a ‘wake-up’ signal from the wearable, the robot uses its onboard camera systems to scan the environment for the specific caregiver or a predefined confirmation gesture (e.g., a hand wave). This handshake protocol ensures that the robot correctly identifies the task location and the specific patient needing assistance without requiring complex infrastructure changes like fixed anchors for indoor positioning.

The interaction logic further provides for real-time feedback to the caregiver. When a call is received and the robot begins navigation, the wearable device may pulse a blue light to indicate ‘Call Received.’ Once the robot arrives at the location and is ready for the task, a green light may flash to signal ‘Call Executed.’ If the robot is busy or unable to fulfill the request due to environmental constraints, a solid red light provides a ‘Rejection’ signal. This just-in-time notification system allows caregivers to remain productive elsewhere until the exact moment their assistance or supervision is required by the robot.

In some embodiments, the workflow is designed to be adaptable based on situational awareness. The control system generates a Standard Operating Procedure (SOP) for each task, such as a bed transfer. Simultaneously, an asynchronous monitoring process uses the platform's sensors to detect environmental changes. For example, if a robot is directed to transfer a patient to ‘Bed 1,’ but its vision system detects that Bed 1 has become occupied by a visitor or another patient during transit, the robot automatically updates its SOP and sends a notification to the caregiver's wearable device to request new instructions or a redirected destination.

Furthermore, the system supports collaborative manipulation where the robot and caregiver work in tandem. While the robot may handle the primary lift, certain tasks—such as placing a patient's feet onto a footrest—may initially require human assistance if the patient has limited mobility. In these scenarios, the robot arrives at the patient and ‘calls’ the caregiver back for the specific sub-task. For safety and regulatory compliance, the protocol may require the caregiver to remain in close proximity to supervise the robot's autonomous lifting sequence, allowing for immediate manual intervention if necessary.

While the primary embodiments are described within the context of a professional care facility where the caregiver makes most decisions, the system is extensible to home environments. In such cases, the wearable device may be worn by the patient themselves, allowing them to initiate requests for sit to stand assistance or repositioning. The robotic platform's ability to coordinate via local Wi-Fi or cloud-based parsing of voice instructions ensures that the assistive workflow remains flexible across various levels of patient mobility and environmental configurations.

FIG. 12 illustrates an interaction logic flow between a mobile robotic platform and a caregiver wearable device (e.g., a wristband) to facilitate a coordinated assistive workflow. The system manages the communication, decision-making, and feedback loops necessary to minimize caregiver wait time and ensure safe patient handling.

Referring to FIG. 12, the workflow begins at the caregiver wristband flow 1200. To initialize the system, the user interacts with the power button 1202. During the connection phase, the power indicator: white blinking signifies that the device is searching for a communication link. Once a link is established 1206 with the robot 1208, the power indicator: solid white 1210 confirms a stable connection.

Once a connection is established, commands can be sent 1212 from the wristband to the robot. For example, to request assistance, the caregiver activates Button 1: Send command Call 1214. Upon initiation, the wristband enters a lights off 1216 state to await a response from the robot. The call robot 1214 logic trigger causes the robot to establish communication connection and register that a call received 1218 event has occurred. The robot then enters a decision 1220 node to evaluate the validity of the command based on environmental constraints or current task priority.

If the command is deemed an invalid command 1222 or if the robot is unable to complete 1224, the caregiver is notified via a signal light: solid red 1226 on the wristband. The user can confirm receipt 1228 using one or more buttons on the wristband. If the robot confirms a valid command 1230, the caregiver acknowledges the robot is in route via one or more buttons on the wristband 1232. During this phase, the wristband displays a signal light: blue flashing 1234.

The robot will then autonomously proceed to target location 1236 using its path recognition and obstacle avoidance navigation 1238 subsystems. Upon arrival, the robot enters an arrive at location (ready) 1240 state. The wristband then updates to a signal light: green flashing 1242, prompting the caregiver to provide a final confirmation 1244 via a wristband button.

In scenarios requiring collaborative manipulation, the robot may call the caregiver 1246 for specific assistance. The robot then processes caregiver voice and action 1248 to refine the command service task and perform a specific action 1250 based on the command(s) received. While awaiting human input or during specific phases of the clinical procedure, the robot remains in a standby in place (25) mode. The control system may then refer to action workflow (26) to execute standardized clinical SOPs.

At any point, the caregiver may utilize the wristband to cancel an action 1252. This triggers a signal light 1254 on the wristband to flash before it automatically turns off. Upon receiving 1256 the cancellation, the robot engages its path recognition and obstacle avoidance navigation 1258 to stop action and return to standby position 1260.

In some embodiments, the chassis and torso are positionable into a posture that is ready to lift a patient. By way of example, the platform may execute a preparatory sequence in which the chassis moves away from the patient while the torso structure pitches toward the patient, thereby bringing one or more support surfaces into proximity with the patient while increasing clearance near the patient's feet. After the patient is appropriately positioned (e.g., with assistance from a caregiver and/or using handles, foot supports, or knee supports), the platform may execute a lifting sequence in which the chassis moves toward the patient while the torso pitches upward, thereby generating a combined kinematic action that supports the patient and assists the patient into standing or into a partially supported posture.

Patient manipulation tasks may include, for example, lifting, sit to stand assistance, stand to sit assistance, and transfer assistance cycles. During a transfer, the control system may coordinate chassis motion, waist pitch, and arm motion to maintain patient stability while moving the patient between support fixtures (e.g., bed, chair, commode). The pressure maps derived from tactile sensors may be used in real time to detect localized high-pressure regions, slipping, or asymmetric loading, and to adjust commanded motion and/or assistance forces accordingly.

In some embodiments, the platform operates in response to a request to assist a patient in a patient environment. The request may be received from a caregiver device, a patient device, a facility scheduling system, a nurse call system, or a local user interface on the platform. In response to the request, the control system may execute one or more navigation tasks in the patient environment using the chassis, identify the patient within the environment (e.g., using visual recognition, room assignment data, and/or wearable identifiers), determine one or more patient assistance tasks to perform based at least on the request, and execute the patient assistance tasks using the control system. During navigation and manipulation, the control system may employ sensor fusion with hierarchical weighting (e.g., LiDAR for global navigation, depth sensing for semantic manipulation, and tactile sensing for contact safety).

In certain embodiments, an autonomous robotic system receives environmental data and/or user data and predicts user intent based on the received data. User data may include, for example, kinematic measurements, gait features, pose features, wearable sensor data, caregiver inputs, or historical mobility profiles. Environmental data may include perceived obstacles, floor conditions, furniture layout, and proximal support fixtures. Based on the predicted user intent, the robotic system may predict a fall or instability event and change a position and/or orientation of the robotic system to mitigate the fall, such as by moving into a catch position, extending a support interface, or presenting a compliant surface to intercept the user.

In some implementations, the system predicts user intent corresponding to a posture change (e.g., initiating a sit to stand or stand to sit transition) and changes a position and/or orientation of the robotic system to provide support for the posture change. The support may include extending one or more support members toward the user to provide physical assistance. In other implementations, the system predicts ambulatory intent corresponding to a user (e.g., intended walking speed, intended direction, start/stop intent) and instructs a propulsion system of the robotic system to move at a speed and in a direction based on the ambulatory intent, thereby providing a guided mobility-assistance mode.

In some embodiments, a system coordinates human-robot assistive workflows in a healthcare environment using a mobile robotic platform, a wearable communication device worn by a caregiver, and a control system in communication with both. The mobile robotic platform may include a chassis, a torso structure, at least one robotic arm, and a vision system configured to detect human gestures. The wearable communication device may include one or more user inputs for initiating a service request and a plurality of feedback indicators. In response to a service request, the control system may direct the mobile robotic platform to navigate to a vicinity of the wearable communication device and localize the caregiver within the vicinity using the vision system, for example by identifying a confirmation gesture performed by the caregiver.

The control system may provide real-time status updates of the service request to the wearable communication device via the plurality of feedback indicators. The feedback indicators may include multimodal outputs, such as at least one multi-color LED signal, a vibration motor, and an audio speaker, to communicate receipt, execution status, estimated time of arrival, task completion, and/or rejection or inability to complete a requested task. In some embodiments, the control system triggers notifications requesting that the caregiver return to the mobile robotic platform to perform a collaborative sub-task that requires human intervention or supervision.

For certain service requests, the control system generates or retrieves a standard operating procedure (SOP) associated with an assistive task, such as a patient transfer from a first location to a second location. While the SOP is being executed, the control system may asynchronously monitor the environment using sensors on the mobile robotic platform to detect environmental changes. If a destination location associated with the task becomes unavailable (e.g., occupied, blocked, or under cleaning), the control system may dynamically update the SOP and notify the wearable communication device. In some implementations, the control system optimizes a navigation plan to minimize caregiver wait time rather than total distance traveled, such as by prioritizing a faster arrival to the caregiver and/or by staging the platform near anticipated demand regions.

To facilitate localization and confirmation, the wearable communication device may transmit an infrared (IR) or ultraviolet (UV) signal perceptible to the vision system of the mobile robotic platform, thereby enabling localization in a spectrum not visible to human eyes. In some embodiments, the control system manages patient transfers via a designated loading zone within a healthcare facility, where the loading zone is identified as having lower congestion or higher maneuverability than a high-traffic area. For example, a caregiver may move a patient in a wheelchair to the loading zone, after which the mobile robotic platform intercepts the patient at the loading zone and autonomously performs a long-distance transport to a destination location, allowing the caregiver to exit the workflow and perform other tasks during transport.

In some embodiments, the wearable communication device includes a first wearable device for the caregiver and a second wearable device worn by the patient. The control system may receive a patient-initiated service request from the second wearable device, where the request corresponds to a mobility-assistance task and/or a personal-care task. The control system may evaluate a mobility level of the patient based on stored patient profile data and determine, based on the mobility level, whether to dispatch the mobile robotic platform to perform the task autonomously or to transmit a notification to the first wearable device to request caregiver supervision. In this manner, the system can adapt autonomy levels to patient risk profiles and facility policies.

In some embodiments, the robotic platform incorporates AI-driven semantic reasoning to support dynamic assistive workflow planning. In some embodiments, the control system includes a machine learning model configured to receive multimodal sensor data, such as visual data from RGB or depth cameras, LiDAR, tactile sensors, microphones, and user input data from caregiver wearables and/or voice interfaces (or other interfaces). The model processes these heterogeneous inputs to generate a unified semantic representation of the environment, capturing high-level concepts such as a patient state (e.g., seated, standing, unstable), a caregiver state (e.g., requesting assistance, supervising), and relevant environmental conditions (e.g., bed occupancy, obstacle presence, congestion). This semantic understanding allows the robot to reason beyond raw sensor signals and to interpret the situation in terms that are meaningful for care delivery.

Based on the generated semantic representation, the control system is able to dynamically select, sequence, or modify an assistive workflow. For example, the machine learning model can determine whether a sit to stand assistance, a transfer operation, or a fall prevention maneuver is most appropriate given the inferred patient intent and context. As environmental or user conditions change (e.g., a caregiver entering or leaving the scene, a destination becoming unavailable, the patient displaying signs of instability, etc.) the workflow may be updated in real time. This enables the robotic platform to move from static, pre-scripted behaviors toward adaptive care workflows that respond continuously to the evolving care environment.

In some embodiments, the underlying method includes receiving multimodal data, generating a semantic representation using a foundation model trained on multimodal inputs, and dynamically selecting or modifying a care workflow based on that representation. The machine learning model performs semantic reasoning across vision, language, and other sensor modalities to enable context understanding, event interpretation, and intent inference. For instance, visual observations of patient posture can be mapped into natural language or symbolic representations (e.g., “patient attempting to stand”), which can be combined with spoken caregiver commands or wearable signals to infer task intent and urgency. This abstraction layer allows care workflows to be planned and adjusted at a semantic level rather than through low-level sensor thresholds alone.

In further embodiments, the machine learning model comprises a vision-language model that aligns visual observations with natural language descriptions and task concepts. By leveraging a foundation model trained on large-scale multimodal data, the system can generalize across different room layouts, patient appearances, and caregiver interaction styles. The semantic representations produced by the model serve as an internal world model for the robot, enabling it to reason about “what is happening” and “what should be done next” in a manner consistent with human caregiving practices. As a result, the robot can support more flexible, intelligible, and context-aware assistive workflows within healthcare and home-care settings.

In some embodiments, the machine learning models in use may include one or more classes of foundation models. Examples of such models include vision-language foundation models which align visual observations with natural-language concepts, enabling the robot to translate images or video into semantic descriptions of patient, caregiver, and environmental states; large multimodal foundation models extend large language models with visual, audio, and other sensory encoders to support integrated context understanding, intent inference, and high-level workflow reasoning across modalities; perception-focused foundation models, such as large vision transformers, provide robust scene understanding, human pose estimation, and activity recognition that serve as inputs to downstream semantic reasoning; and embodied or robotics-oriented foundation models, trained on large-scale robot interaction data, link perception and semantics directly to action, enabling adaptive task execution and dynamic assistive workflow planning in real-world care environments.

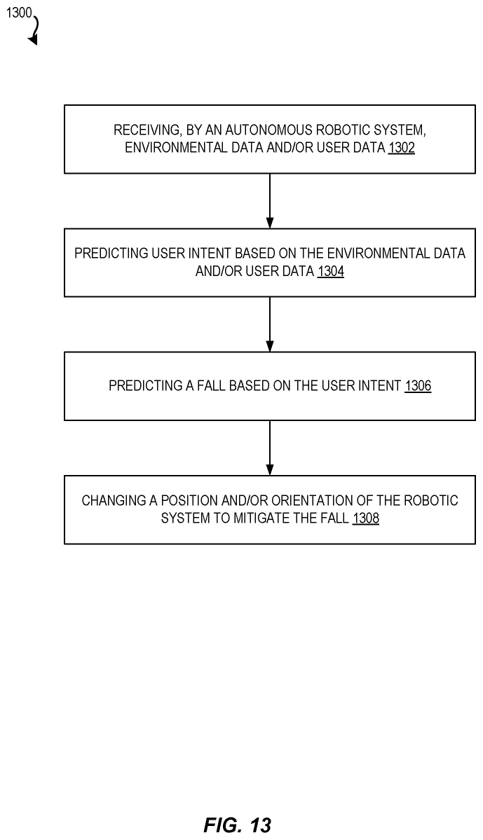

FIG. 13 illustrates a flowchart of a series of acts in a method of autonomous robotic assistance in accordance with one or more embodiments. In particular, FIG. 13 depicts an example method 1300 that may be performed by a mobile robotic platform (e.g., any of the mobile robotic platforms described herein) to provide physical assistance to a user in connection with mobility maneuvers such as posture transitions, walking support, and/or fall prevention. The acts of method 1300 may be performed autonomously and/or semi-autonomously by the autonomous robotic system using one or more control systems (e.g., a navigation control system and a task/patient control system) in communication with one or more perception sensors and/or user devices. In one or more embodiments, the method 1300 may be executed based on explicit user commands (e.g., voice commands, app commands, caregiver wearable device commands) and/or implicit cues inferred from sensor data (e.g., changes in user posture, instability, or gait patterns). While FIG. 13 illustrates one example ordering of acts, the acts may be reordered, combined, repeated, omitted, or performed in parallel consistent with the present disclosure.

The method 1300 includes an act 1302 of receiving, by an autonomous robotic system, environmental data and/or user data. In one or more embodiments, the autonomous robotic system receives environmental data from one or more onboard and/or external sensing systems, such as one or more cameras (including RGB and/or depth cameras), LiDAR, ultrasonic proximity sensors, microphones, wheel odometry, and inertial measurement units (IMUs). The environmental data may represent, by way of example and not limitation, one or more of: a map of the environment (e.g., for SLAM), obstacle locations, free-space/aisle geometry, surface conditions, proximity to furniture (e.g., beds, chairs, wheelchairs), and the presence or motion of bystanders. Additionally, in one or more embodiments, the autonomous robotic system receives user data indicative of a user state, such as user position relative to the robotic platform, user posture (e.g., seated, standing, lying), joint angles, gait characteristics, motion trajectories, hand/arm placement, and/or contact force information (e.g., from pressure sensors, tactile electronic skin, or grip-point sensors on support structures). In some embodiments, the user data may additionally include user device data received from a user device and/or caregiver device (e.g., a wearable wristband) including explicit requests, confirmations, cancellations, and/or physiological or motion measurements that indicate user instability (e.g., increasing unsteadiness over time). The received data may be collected continuously, periodically, or on-demand (e.g., in response to a wake word, a call command from a wearable device, or an identified need for assistance), and may be provided to one or more control modules and/or machine learning models for downstream decision-making.

The method 1300 also includes an act 1304 of predicting user intent based on the environmental data and/or user data. In one or more embodiments, predicting user intent includes applying one or more machine learning models and/or rules-based logic to infer an assistance need or a likely next movement of the user. For example, the autonomous robotic system may infer that the user intends to perform a posture transition (e.g., sit to stand, stand to sit, lying-to-seated, seated-to-lying), intends to ambulate (e.g., initiate walking, change speed or direction), and/or intends to initiate a transfer (e.g., bed-to-wheelchair, wheelchair-to-bed). The user intent may be inferred from multimodal signals including user speech, detected gestures, body language, posture changes, and/or contact forces between the user and the robotic platform. In some embodiments, an ensemble of models is used in which different models analyze different sensor streams, such as an environment model, a user position model, a user posture model, and/or a fall prediction model, and the outputs of those models are fused (e.g., by a user intent model) to generate a predicted intent and an associated confidence score. In some embodiments, a machine learning model manager hosts one or more neural networks (e.g., convolutional neural networks, recurrent neural networks, transformer-based networks, and/or large language models) that execute locally on the robot and/or remotely (e.g., in a cloud environment). Based on the predicted intent, the autonomous robotic system may select an assistance behavior and generate control objectives for one or more action systems, such as a propulsion/navigation system, a support system configured to extend support members, and/or a patient manipulation system configured to position robotic arms and torso posture to support the user safely.

The method 1300 also includes an act 1306 of predicting a fall based on the user intent. In one or more embodiments, fall prediction includes determining that a fall event is imminent or likely to occur during execution of the predicted user intent, such as during a posture transition or initiation of ambulation, which may correspond to higher fall-risk phases. For example, the autonomous robotic system may detect abnormal or rapidly changing force profiles at contact points (e.g., at handles, straps, support members, arm surfaces with tactile sensing elements, and/or a patient support surface) that are indicative of loss of balance, slipping, or a sudden weight shift. Additionally, or alternatively, the autonomous robotic system may analyze vision-based or depth-based pose estimates and identify sudden changes in user center-of-mass trajectory, abnormal joint kinematics, foot placement instability, or unexpected accelerations consistent with a stumble. In some embodiments, a fall detection and prevention system utilizes a fall prediction model that processes fused sensor inputs to output a fall probability and/or predicted fall direction. In one or more embodiments, the autonomous robotic system may incorporate context from the environment (e.g., proximity to obstacles, edges, furniture, or narrow aisleways) when predicting fall likelihood and selecting a mitigation strategy. The fall prediction may be updated continuously as the user moves and as the robot changes its own state, enabling closed-loop adjustment of assistance behaviors in real time.

The method 1300 also includes an act 1308 of changing a position and/or orientation of the robotic system to mitigate the fall. In one or more embodiments, in response to the predicted fall (and/or in response to detecting conditions exceeding a safety threshold), the autonomous robotic system generates and executes control signals that reposition the chassis and/or reorient the torso structure (e.g., via a waist joint) to improve stability and to provide physical support to the user. For example, the propulsion system may execute an emergency braking maneuver, widen or adjust wheel stance (e.g., through steering joints and steering modes), and/or translate laterally (e.g., in an omnidirectional or crab steering mode) to move a support surface into a stabilizing position relative to the user. Additionally, or alternatively, a support system may extend one or more support members (e.g., handles, straps, or other support structures) toward the user based on the received environmental and/or user data to catch, arrest, or slow the user's descent. In some embodiments, a patient manipulation system positions one or more robotic arms under a user's arms and/or adjusts an effective shoulder width (e.g., via a lateral positioning mechanism) to provide a secure and comfortable support geometry for the user while maintaining a compliance envelope based on tactile sensing signals. The autonomous robotic system may further provide multimodal feedback (e.g., audio prompts, on-screen prompts, wearable device alerts) to coordinate with the user and/or a caregiver during the mitigation response. In one or more embodiments, the fall mitigation actions are performed in a closed-loop manner using continuous sensor feedback, such that the robotic system adjusts its position, orientation, and/or support forces to maintain user safety and comfort until the risk condition has passed and/or the user has completed the posture transition or other intended movement.

In some embodiments, a method comprises receiving, by an autonomous robotic system, environmental data and/or user data. The autonomous robotic system predicts user intent corresponding to a posture change based on the environmental data and/or user data. The autonomous robotic system changes a position and/or orientation of the autonomous robotic system to provide support for the posture change, wherein the support includes extending one or more support members of the autonomous robotic system toward the user based on the environmental data and/or user data to provide physical assistance to the user.

In some embodiments, a method comprises receiving, by an autonomous robotic system, environmental data and/or user data. The autonomous robotic system predicts ambulatory intent corresponding to a user based on the environmental data and/or user data. The autonomous robotic system instructs a propulsion system of the autonomous robotic system to move in a speed and at a direction based on the ambulatory intent.

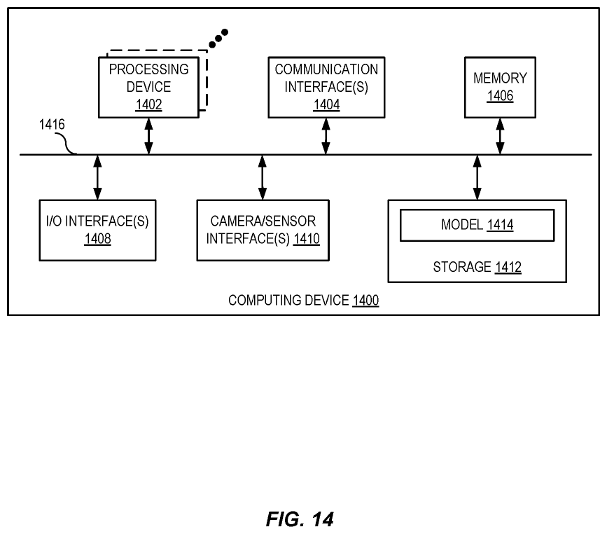

FIG. 14 illustrates a block diagram of an exemplary computing device 1400 in accordance with one or more embodiments. The computing device 1400 may be configured to perform one or more of the processes described above. As shown in FIG. 14, the computing device can comprise a processing device 1402, communication interface(s) 1404, memory 1406, I/O interface(s) 1408, video capture device (e.g., camera) interface(s) 1410, and a storage device 1412 including at least one model 1414. In various embodiments, the computing device 1400 can include more or fewer components than those shown in FIG. 14. The components of computing device 1400 are coupled via a bus 1416. The bus 1416 may be a hardware bus, software bus, or combination thereof.

Processing device 1402 includes hardware for executing instructions. The processing device 1402 is configured to fetch, decode, and execute instructions. The processing device 1402 may include one or more central processing units (CPUs), graphics processing units (GPUs), accelerators, field programmable gate arrays (FPGAs), systems on chip (SoC), or other processor(s) or combinations of processors.

A communication interface(s) 1404 can include hardware and/or software communication interfaces that enable communication between computing device900 and other computing devices or networks. Examples of communication interface(s) 1404 include a network interface controller (NIC) or network adapter for communicating with an Ethernet or other wire-based network or a wireless NIC (WNIC) or wireless adapter for communicating with a wireless network, such as a WI-FI, etc.

Memory 1406 stores data, metadata, programs, etc. for execution by the processing device. Memory 1406 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1406 may be internal or distributed memory.

In some embodiments, the computing device 1400 includes input or output (“I/O”) interfaces 1408. The I/O interface(s) enable a user to interact with (e.g., provide information to and/or receive information from) the computing device 1400. Examples of devices which may communicate via the I/O interfaces 1408 include a mouse, keypad or a keyboard, a touch screen, camera, optical scanner, network interface, modem, or other I/O devices. The I/O interfaces 1408 may also facilitate communication with devices for presenting output to a user. This may include a graphics engine, a display (e.g., a display screen), one or more output drivers (e.g., display drivers), one or more audio speakers, and one or more audio drivers. In some embodiments, graphical data corresponding to a graphical user interface is provided to a display for presentation to a user using the I/O interfaces.

In some embodiments, computing device 1400 may include camera interfaces 1410. Camera interfaces 1410 may include high speed, high bandwidth, or otherwise specialized or dedicated interfaces to facilitate the transfer of large quantities of video data for processing by the computing device 1400 in real time.

The computing device 1400 also includes a storage device 1412 for storing data or instructions, and one or more machine learning models 1414, as described herein. As an example, and not by way of limitation, storage device 1412 can comprise a non-transitory computer readable storage medium. The storage device 1412 may include a hard disk drive (HDD), flash memory, a Universal Serial Bus (USB) drive or a combination of these or other storage devices.

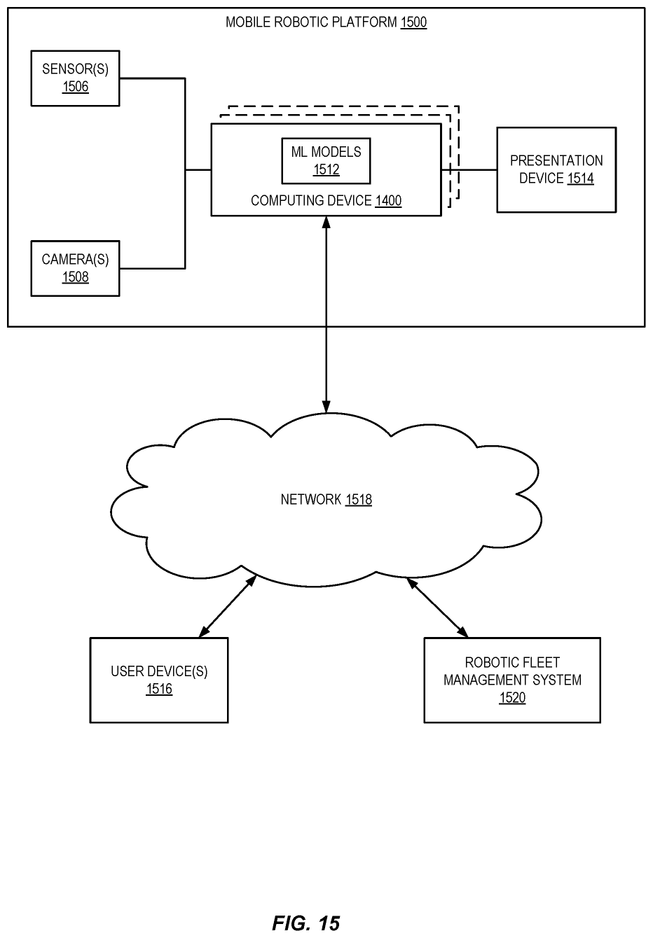

FIG. 15 illustrates a block diagram of an exemplary system in accordance with one or more embodiments. In the example of FIG. 15, mobile robotic platform 1500 includes a computing device 1400 on which various machine learning models can execute in accordance with one or more embodiments. The mobile robotic platform 1500 includes one or more cameras 1508 in communication with the computing device 1400 (e.g., via local wired or wireless networks). In some embodiments, the mobile robotic platform may also include one or more sensors 1506-2108. These may include other devices which capture information about the mobile robotic platform, such as audio sensors, LiDAR sensors, rangefinders, monocular cameras, non-visible spectra cameras, etc.

A user may access the computing device 1400 via a local presentation device 1514 (e.g., monitor) and user input devices, or remotely via one or more client devices 1516. When accessed remotely, the computing device 1400 is accessed over one or more networks 1518, such as the Internet. In some embodiments, a robotic fleet management system 1520 may be provided by a service provider or other entity to facilitate communication over the Internet between multiple mobile robotic platforms. In various embodiments, the components shown in FIG. 15 may communicate using any communication platforms and technologies suitable for transporting data and/or communication signals, including any known communication technologies, devices, media, and protocols supportive of remote data communications.

As illustrated in FIG. 15, the environment may include user devices 1516. The user devices 1516 may comprise any computing device. For example, user devices 1516 may comprise one or more personal computers, laptop computers, mobile devices, mobile phones, tablets, special purpose computers, TVs, pendants or other emergency call devices, or other computing devices.

The one or more networks 1518 may represent a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the one or more networks 1518 may be any suitable network over which the client devices 1516 may access computing device 1400, monitoring service 1520, or vice versa.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

1. A mobile robotic platform for patient assistance comprising:
a chassis adapted to perform one or more navigation tasks;
a torso structure coupled to the chassis via a waist joint, the waist joint configured to pitch the torso structure relative to the chassis, the waist joint being driven by one or more motors;
one or more robotic arms mounted to the torso structure to perform one or more patient manipulation tasks; and
a control system configured to autonomously control the one or more navigation and manipulation tasks of the robotic platform.

2. The mobile robotic platform of claim 1, wherein the chassis comprises a locomotion system, the locomotion system including wheel-based, tread-based, or hybrid-based components.

3. The mobile robotic platform of claim 2, further comprising:
one or more servo actuators configured to independently control steering angles of each wheel using associated steering linkages.

4. The mobile robotic platform of claim 1, wherein the mobile robotic platform is operable in different navigation modes including one or more of a crab steering mode, an omnidirectional steering mode, a pivot turning mode, and an Ackerman mode.

5. The mobile robotic platform of claim 1, wherein each of the one or more robotic arms is mounted to a shoulder joint configured to move the robotic arms outward or inward in a horizontal direction to vary an effective shoulder width of the platform.

6. The mobile robotic platform of claim 5, wherein the shoulder joint is configured to automatically adjust shoulder width based on environmental dimensions or patient characteristics.

7. The mobile robotic platform of claim 1, wherein the waist joint is driven by dual motors.

8. The mobile robotic platform of claim 1, further comprising a sensor system that is capable of sensing surrounding environment and scenes.

9. The mobile robotic platform of claim 8, further comprising a control system which uses data collected by the sensor system to perform at least mapping, navigation or manipulation.

10. The mobile robotic platform of claim 9, further comprising one or more patient support surfaces which include one or more tactile sensors, wherein the control system is further configured to use data collected by the tactile sensors to generate real-time pressure maps for use in the patient manipulation tasks.

11. The mobile robotic platform of claim 9, wherein the control system is configured to select among different steering mode profiles based on environmental classification derived from a perception system.

12. The mobile robotic platform of claim 9, wherein the control system is configured to transition between a navigation mode and a manipulation mode based on proximity thresholds.

13. The mobile robotic platform of claim 9, wherein the control system is configured to fuse sensor data from the sensors.

14-17. (canceled)

18. A system for coordinating human-robot assistive workflows in a healthcare environment, comprising:
a mobile robotic platform comprising a chassis, a torso structure, at least one robotic arm, and a vision system configured to detect human gestures;
a wearable communication device configured to be worn by a caregiver, the device comprising at least one user input for initiating a service request and a plurality of feedback indicators; and
a control system in communication with the mobile robotic platform and the wearable communication device, the control system configured to:
receive a service request from the wearable communication device;
direct the mobile robotic platform to navigate to a vicinity of the wearable communication device;
localize the caregiver within the vicinity using the vision system to identify a confirmation gesture; and
provide real-time status updates of the service request to the wearable communication device via the plurality of feedback indicators.

19. The system of claim 18, wherein the control system is further configured to manage patient transfers via a designated loading zone, the loading zone comprising a physical area of a facility identified by the control system as having lower congestion or higher maneuverability than a high-traffic area.

20. The system of claim 19, wherein the control system instructs the mobile robotic platform to:
intercept a patient at the loading zone after a caregiver has moved the patient to the loading zone; and
autonomously perform a transport of the patient from the loading zone to a destination location.

21. A method of patient assistance using a mobile robotic platform comprising:
receiving a request to assist a patient in a patient environment using an autonomous robotic platform;
executing one or more navigation tasks in the patient environment using a chassis of the autonomous robotic platform;
identifying the patient in the patient environment;
determining one or more patient assistance tasks to perform based at least on the request to assist the patient; and
executing the one or more patient assistance tasks using a control system of the robotic platform, the control system to autonomously control the one or more navigation and patient assistance tasks using a sensor fusion module configured to apply hierarchical weighting to sensor streams wherein a bottom-mounted LiDAR sensor is assigned primary priority for global navigation, a wrist-mounted depth camera is assigned primary priority for mid-range semantic manipulation, and tactile sensing elements are assigned primary priority for near-contact and contact safety control.

22. The method of claim 21 wherein determining one or more patient assistance tasks to perform based at least on the request to assist the patient further comprises:
predicting patient intent based at least on data received from the sensor fusion module.

23. The method of claim 22, wherein patient intent is predicted based at least on a posture change of the patient identified based at least on the data received from the sensor fusion module.

24. The method of claim 22, wherein executing the one or more patient assistance tasks using a control system of the robotic platform, further comprises:
changing a position and/or orientation of the robotic platform to provide support for the patient, wherein the support includes extending one or more support members of the robotic platform toward the user based at least on the data received from the sensor fusion module to provide physical assistance to the patient.
